(19) United States
(12) Patent Application Publication
(10) Pub. No.: US 2008/0034023 A1
(43) Pub. Date: Feb. 7, 2008

(54) CONTACT GEOMETRY CALCULATION DEVICE, CONTACT GEOMETRY CALCULATION METHOD, AND COMPUTER PROGRAM PRODUCT

(76) Inventor: Masakuni NAGANO, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/831,032

(22) Filed: Jul. 31, 2007

(30) Foreign Application Priority Data
Aug. 2, 2006 (JP) 2006-210597

(51) Int. Cl. G06F 17/10

(52) U.S. Cl. 708/100

(57) ABSTRACT

A contact geometry calculation device includes means for decomposing each object into a group of convex segments or inputting information of the object decomposed into a group of convex segments, means for detecting a convex segment in a colliding condition or a contact condition between the objects colliding or osculating with each other, means for determining a virtual contact plane passing through a common area to convex hulls of the respective objects colliding or osculating with each other, means for solving a contact condition between each of the convex segments and the virtual contact plane colliding or osculating with each other as individual semi-contact problems, and means for determining a contact polygon between the objects colliding or osculating with each other by coordinating the solutions of the semi-contact problems obtained by the means for solving for every convex segment.

### CROSS REFERENCE TO RELATED APPLICATIONS

The present invention contains subject matter related to Japanese Patent Application JP 2006-210597 filed in the Japan Patent Office on Aug. 2, 2006, the entire contents of which being incorporated herein by reference.

### BACKGROUND OF THE INVENTION

1. Technical Field

The present invention relates to a contact geometry calculation device, a contact geometry calculation method, and a computer program for detecting contacts among a plurality of three-dimensional objects and calculating a contact geometry between two objects in a contact condition, and in particular to a contact geometry calculation device, a contact geometry calculation method, and a computer program for calculating a contact polygon formed between the two objects in a situation in which the both objects collide or have a contact with each other.

In further detail, the present invention relates to a contact geometry calculation device, a contact geometry calculation method, and a computer program for calculating the contact polygon between objects with complicated shapes at high-speed and completely, and in particular to a contact geometry calculation device, a contact geometry calculation method, and a computer program for robustly and exactly calculating a group of contact polygons formed among objects with arbitrary shapes including a concave shape.

2. Related Art

It is necessary to detect that a collision between objects occurs and figure out the contact condition between the objects by introducing a dynamics simulation and so on for reproducing physical interactions such as a collision or a contact between a plurality of objects coexisting in a virtual environment on a computer, thereby making appropriate reaction force act on the colliding portion.

For example, in a legged locomotion robot such as a humanoid, it is necessary that by introducing a dynamics simulation and so on for reproducing a physical interaction such as a collision or a contact on a computer by detecting a collision or a contact between palms of the feet of the both legs and a floor face, or between the palms of the feet of the both legs and a plurality of objects existing in the working surroundings, and more exactly calculating a shape of an area, namely “a contact polygon,” on which the floor face or the objects and the robot manually exert a force, occurrence of the collision between the solid bodies is detected, and at the same time, the contact condition between the objects is figured out to make appropriate reaction force act on the colliding place.

For example, as shown in FIG. 42, when the two cubes A and B are contiguous with each other, it is necessary to make the reaction force act on each of the apexes v1, v2, v3, and v4 forming the contact geometry. When the two solid bodies are in contact condition, the shape of the contact section between the two solid bodies such as the figure v1-v2-v3-v4 is the contact polygon.

However, most of well-known collision detection algorithms used for collision detection or collision place calculation between objects can only obtain a part of collision points between the two solid bodies, but cannot completely calculate the contact polygon. Only an incomplete output for performing a stable dynamics simulation such as a single representative point (typically the point (the most penetrating point, a penetration depth) which penetrates the most deeply, or the point (the nearest neighbor) which comes closest thereto) per one collision as shown in FIG. 43, or a triangle mesh generating a collision as shown in FIG. 44 can be provided.

A dynamics simulation executed directly using an insufficient collision detection algorism result causes a disadvantage. Here, an observation on the case in which a cube is put on a horizontal floor will be described as an example. For example, when reaction force is made act only on the representative point P as shown in FIGS. 45A and 45B, if a floor reaction force model does not have restoring force, as shown in FIG. 45A, the opposite end to the Point P is not supported, and accordingly, the cube gradually penetrates the floor from the opposite end while rotating around the point P. Then, when the simulation progresses by one frame, a point Q becomes the point penetrating the most deeply, and the reaction force acts on the point Q instead of the point P, and accordingly, the cube rotates around the point Q and the point P further penetrates in turn. When the condition described above is repeated, the cube problematically penetrates the floor face endlessly. Further, if the floor reaction force model has the restoring force, as shown in FIG. 45B, although the penetration dose not proceed beyond a certain amount, the point of action moves shuttlewise between the point P and the point Q to cause a vibration, and accordingly, a preferably simulation result can hardly be obtained.

Further, since most of objects existing in the real world are objects including a concave shape, not only the convex shape but also more generic shapes including a concave shape should be addressed. However, interference detection of a concave-shaped object requires a large amount of calculation in comparison with a convex-shaped object, and accordingly, there is a possibility that the real-time property of the simulation is significantly degraded as the shape becomes complicated and the number of objects increases.

It is possible to perform the collision detection of the object including a concave shape by a shape approximated to a convex shape using various types of bounding volume methods such as a convex hull algorithm (see e.g., Barber, C. Bradford, David Dobkin, Hannu Huhdanpaa, “The Quickhull Algorithm for ConvexHulls” (ACM Transactions on Mathematical Software, vol. 22, no. 4, pp. 469-483, 1996)), an axis-aligned bounding box (AABB, see e.g., C. Ericson, “Real-Time Collision Detection” (Morgan Kaufmann Publishers, 2005)), a bounding sphere (see e.g., Ritter, Jack, “An Efficient Boundering Sphare” (in Andrew Glassner (ed.), Graphics Gems, Academic Press, pp. 301-303, 1990), an oriented bounding box (see e.g., Eric Lengyel, “Mathematics for 3d Game Programming and Computer Graphics” (Charles River Media, 2001)), or a discrete orientation polytope (k-DOP, see e.g., Konecny, Petr. Karel Zikan, “Lower Bound of Distance in 3D” (Proceeding of WSCG 1997, vol. 3, pp. 640-649, 1997)). However, in order for realizing a dynamics simulation with a sense of reality or a precise real-time motion planning of a locomotive robot under a complicated environment, it is necessary that the collision detection is performed on the concave shape without modification to calculate more exact inter-object contact polygon group.

Further, a proposal has been made regarding a collision detection device for detecting a collision by generating a solid model hierarchically representing an object in the three-dimensional space with respect to the position, namely an octree, for every object, and tracing each of the octrees in parallel with each other (see e.g., JP-A-2005-310021). In the device, by modifying (expanding) the definition of three kinds of nodes of the octree so that the octree generation of the object including a concave shape becomes possible, the octree generation of the object including the concave shape is realized. However, in the case in which the number of faces forming the object is large, the octree generation time becomes very long, and accordingly, distributed processing or parallel processing with a number of computers such as grid computing is required, which causes a disadvantage in a high-speed property and a real-time property.

### SUMMARY

It is desirable to provide a superior contact geometry calculation device, a contact geometry calculation method, and a computer program capable of fast and completely calculating the contact polygon between the objects having complicated shapes.

It is further desirable to provide to superior contact geometry calculation device, a contact geometry calculation method, and a computer program capable of robustly and exactly calculating a group of contact polygons formed between objects with arbitrary shapes including a concave shape.

According to an embodiment of the invention, there is provided a contact geometry calculation device for calculating a contact geometry between two objects with arbitrary shapes in a contact condition including

convex segment complex obtaining means for one of decomposing each object into a group of convex segments and inputting information of the object decomposed into a group of convex segments,

inter-convex segment collision detection means for detecting a convex segment in one of a colliding condition and a contact condition between the objects one of colliding and osculating with each other,

virtual contact plane determination means for determining a virtual contact plane passing through a common area to convex hulls of the respective objects one of colliding and osculating with each other,

semi-contact problem solving means for solving a contact condition between each of the convex segments and the virtual contact plane one of colliding and osculating with each other as individual semi-contact problems, and

contact polygon determination means for determining a contact polygon between the objects one of colliding and osculating with each other by coordinating the solutions of the semi-contact problems obtained by the semi-contact problems solving means for every convex segment.

In the field of a dynamics simulation, in a virtual environment where a plurality of objects coexist, a physical interaction such as a collision or contact between the objects is reproduced on a computer. Here, when a collision between the objects occurs, in order for applying appropriate reacting force to the portion of collision, it is necessary to obtain fast further accurate contact polygon between the objects.

However, most of the well-known collision detection algorithm can only obtain a part of the collision points between the two solid bodies, such as one representative point P (typically, the most penetrating point or the nearest point) per one collision or the triangle mesh M causing a contact, and accordingly, it is quite difficult to completely calculate the contact polygon. A dynamics simulation executed directly using such an insufficient collision detection algorism result causes a disadvantage.

Further, since most of objects existing in the real world are objects including a concave shape, not only the convex shape but also more generic shapes including a concave shape should be addressed. However, interference detection of a concave-shaped object requires a large amount of calculation in comparison with a convex-shaped object, and accordingly, there is a possibility that the real-time property of the simulation is significantly degraded as the shape becomes complicated and the number of objects increases.

In consideration of that circumstances, in an embodiment of the invention, it is arranged that by executing only the local search on the pairs of collision representative points (a pair of the most penetrating point or a pair of the nearest neighbors) obtained by an existing collision detection algorithm, accurate contact polygon can be calculated faster.

If the contact condition between two objects, a collision or a contact of which has been detected, is treated directly, various combinations exist, and accordingly, the problem becomes more complicated, resulting in a heavy calculation load. Therefore, in the embodiment of the invention, a contact plane passing through a common area of the two objects is defined, the semi-contact problem between each of the objects and the contact plane is separately solved, and the solutions of the semi-contact problems between the objects and the contact plane are coordinated, thereby contact geometry between the two desired objects can be calculated.

Further, when the contact polygon formed between the objects including a concave shape is calculated, by convex-dividing the concave polyhedron not convex into a plurality of convex segments, and treating the concave object as a complex composed of a plurality of convex segments, the efficient algorithm for a convex object is applied to collision judgment between the concave objects.

If the collision detection process and the contact polygon calculation process are separately executed for every combination of the convex segments in contact with each other, a preferable simulation can be performed considering the calculation result for every convex segment. However, in the case in which the concave objects osculate with a plurality of convex segments, there are some cases in which the directions of the normal lines of the contact planes independently set for every combination of the convex segments are not the same, and if the force in the direction of the normal line is applied to each apex of each of the contact polygons, the acting points and acting directions of the force may face each other, the penetrating state is not eliminated, and it is difficult to obtain a preferable simulation result.

Therefore, in an embodiment of the invention, by solving the contact problem for each convex segment the collision or the contact of which is detected considering the direction of elimination of penetration, the penetration elimination problem between the convex complex (concave object) can also be solved.

Specifically, the virtual contact plane determination means calculates a pair of convex hull collision representative points composed of one of the nearest neighbor and the most penetrating point between the convex hulls of the respective objects one of colliding and osculating with each other, and determines a virtual contact plane passing through the midpoint of the pair of convex hull collision representative points and having a normal vector directed along a line connecting the pair of convex hull collision representative points. Further, the semi-contact problem solving means obtains a semi-contact polygon for each convex segment in one of a colliding condition and a contact condition with another convex segment, the semi-contact polygon providing a contact geometry with the virtual contact plane, and the contact polygon determination means obtains a product area for each combination of the convex segments one of colliding and osculating with each other, the semi-contact polygons overlapping on the product area, and determines a contact polygon between the objects by coordinating the product areas.

Therefore, since the contact problem can be solved using the unified virtual contact plane having the normal vector in the direction for eliminating the collision for all of the combinations of the convex segments a collision or a contact of which is detected, the reaction force is applied simultaneously at the apexes of the a plurality of contact polygons having a physical basis, the vibration can be eliminated, and a stable dynamics simulation can be performed.

The adjacent apex graph representing the connection relationships of the apexes is held for each convex segment obtained by the convex segment complex obtaining means. Then, the semi-contact problem solving means searches the adjacent apex graph relating to the convex segment to be the processing target to obtain a apex set existing in the semi-contact polygon, recursively performs a local search of the adjacent apex graph until an apex not existing in the virtual session plane is reached taking an appropriate apex as an origin to obtain the apex set existing in the semi-contact polygon. By performing the local search instead of the exhaustive search, the semi-contact polygon can be obtained fast and with small amount of calculation.

As the appropriate origin mentioned here, the most penetrating apex in the convex segment to be the counterpart of the contact in the normal vector direction out of the convex segment to be the processing target can be set as the origin. Such an origin can be obtained from the support mapping in the normal vector direction or the inverted direction thereof.

The local search of the adjacent apex list can be started from the origin thus set, and it is sufficient that the apex existing on the side of the object to be the counterpart of the contact from the contact plane is sequentially extracted as the apex existing in the semi-contact polygon. Then, if the apex, which has already been searched, or the apex, which exists above the contact plane, is reached, there is no need to trace the adjacent apex graph any further. The set of the apexes existing below the contact plane and obtained before that time is used as the set of the points on the periphery of the semi-contact polygon and the points inside the semi-contact polygon.

Further, the apex set obtained by searching on the adjacent apex graph along the procedure described above also includes a point existing inside the semi-contact polygon in general. Therefore, the semi-contact problem solving means is arranged to remove a redundant point such as the apex existing inside the semi-contact polygon out of the apexes of the extracted convex segment from the apex set. For example, it is possible that the apex set extracted as existing in the semi-contact polygon is orthogonally projected on the virtual contact plane, an operation for obtaining the minimum convex polygon apex set including the apex group orthogonally projected is performed, and a contour apex set of the semi-contact polygon excluding the inner point on the contact plane can be calculated.

Further, in most of the dynamics simulations, the reaction force is often generated so that the objects do not penetrate each other. In the case in which such a non-penetration model is handled, it should be configured that the collision detection is performed on the figures expanded by the radius (r) of the sphere, the semi-contact polygon between the plane (offset virtual contact plane) obtained by shifting the virtual contact plane in the normal vector direction and the convex segment is calculated, and the intersection of the semi-contact polygons obtained from the respective convex segments is obtained.

In the case in which interfere is not caused between the original objects, the pair of the nearest neighbors between the two objects can be calculated by the existing collision detection algorithm in stead of the pair of the most penetrating points as the pair of collision representative points. Therefore, in the non-penetration model, the virtual contact plane is defined to pass through the midpoint of the pair of the nearest neighbors and to have the direction of the straight line connecting the pair of the nearest neighbors as the normal vector thereof.

Here, although there are various methods of determining the offset amount r, it is preferable to arrange that the intersection between the offset virtual contact plane and the original object is assured. In such a case, when the semi-contact polygon is calculated for each of the convex segments, the offset virtual contact plane obtained by shifting the virtual contact plane towards the side of the object in question by r is set, and the search in the adjacent apex graph can be performed for each convex segment by the similar way as described above.

Further, according to a second embodiment of the invention, there is provided a computer program described in a computer readable form for performing a process for calculating a contact geometry between two objects with arbitrary shapes in a contact condition, the computer program allowing a computer to execute a process including the steps of

one of decomposing each object into a group of convex segments and inputting information of the object decomposed into a group of convex segments,

detecting a convex segment in one of a colliding condition and a contact condition between the objects one of colliding and osculating with each other,

determining a virtual contact plane passing through a common area to convex hulls of the respective objects one of colliding and osculating with each other,

solving a contact condition between each of the convex segments and the virtual contact plane one of colliding and osculating with each other as individual semi-contact problems, and

determining a contact polygon between the objects one of colliding and osculating with each other by coordinating the solutions of the semi-contact problems obtained by the solving step for every convex segment.

The computer program according to this embodiment of the invention defines the computer program described in a computer-readable form so as to realize a predetermined process on a computer system. In other words, by installing the computer program according to this embodiment in the computer system, a cooperant action is exerted on the computer system, and the same advantage as the contact geometry calculation device can be obtained.

According to the contact geometry calculation device of an embodiment of the invention, it becomes possible to perform the interference detection between the objects with arbitrary shape including not only a convex shape but also a concave shape, and it becomes possible to handle a wide variety of objects existing in the real world.

According to the contact geometry calculation method of an embodiment of the invention, further accurate contact polygons can be obtained. Therefore, in comparison with the case in which the force is applied only to the pair of collision representative points or the apex of a single contact polygon, which have been obtained by the past interference detection algorithm, since the reaction force is applied to the apexes of a plurality of contact polygons having a physical basis simultaneously, the vibration can hardly be caused and stable dynamics simulation can be performed.

Further, according to the contact geometry calculation method of an embodiment of the invention, the calculation of the convex contact polygon can be performed to the convex segment by executing only the local search without performing the exhaustive search of all of the apexes of the object a collision or a contact of with is detected, and further, the inter-convex segment collision detection can be configured using the convex shape based efficient interference detection algorithm, thus the fast simulation can be made possible. In other words, the dynamics simulation provided with stability, robustness, and high-speed processing can be realized.

The contact geometry calculation device according to an embodiment of the invention can preferably be applied to a system necessary for figuring out the variously changing physical contact condition with the surrounding environment such as a locomotive robot. Specifically, by applying the contact geometry calculation process according to the present embodiment of the invention to the three-dimensional geometry model of the environmental shape obtained by the image processing and sensing processing (range sensor) and the locomotive robot itself, the complicated contact condition between the locomotive robot and the environment can be obtained fast, further generalized posture stabilizing control and the motion planning under the various environments can be realized.

Other objects, features, and advantages of the invention will become apparent from the embodiments of the invention described below and further detailed explanations with reference to the accompanying drawings.

### BRIEF DESCRIPTION OF THE DRAWINGS

FIG. 1 is an enlarged view of a contact section between solid bodies A and B viewed from the side thereof.

FIG. 2 is a diagram showing the condition in which a contact problem between the solid bodies A and B is divided into a contact problem between a contact plane CP and one solid body A of the solid bodies and a contact problem between the contact plane CP and the other solid body B.

FIG. 3 is a diagram showing representative points Pa and Pb obtained from the respective solid bodies by a collision detection algorithm.

FIG. 4 is a diagram showing how a support mapping in a vector direction illustrated by an arrow with respect to a certain solid body R is obtained.

FIG. 5 is a diagram showing the condition in which a graph of adjacent apexes is locally searched taking an appropriate apex as an origin to obtain a final semi-contact polygon between the solid body A and the contact plane.

FIG. 6 is a diagram showing the condition in which an apex is set at the center of a face of the solid body, and is included as a result of the apex search.

FIG. 7 is a diagram showing how an overlapping area is obtained form the respective semi-contact polygons of the solid bodies A and B on the contact plane.

FIG. 8A is a perspective view of an object A having a concave shape.

FIG. 8B is a perspective view of an object B having a concave shape.

FIG. 9A is a plan view of the object A having a concave shape.

FIG. 9B is a plan view of the object B having a concave shape.

FIG. 10A is a diagram showing the condition in which the object A having a concave shape is convex-decomposed into a group of convex segments.

FIG. 10B is a diagram showing the condition in which the object B having a concave shape is convex-decomposed into a group of convex segments.

FIG. 10C is a diagram showing the condition in which the object A having a concave shape is convex-decomposed into a group of convex segments.

FIG. 10D is a diagram showing the condition in which the object B having a concave shape is convex-decomposed into a group of convex segments.

FIG. 11 is a diagram showing the condition in which the object A and the object B collide with each other.

FIG. 12 is a diagram for explaining interference detection processing method for the case in which the object A and the object B collide with each other as shown in FIG. 11.

FIG. 13A is a diagram showing {V_{A1}_{_{—}}₁, V_{A1}_{_{—}}₂} existing in the positive area of the contact plane CP obtained by the local search.

FIG. 13B is a diagram showing {V_{B1}_{_{—}}₁, V_{B1}_{_{—}}₂} existing in the positive area of the contact plane CP obtained by the local search.

FIG. 14A is a diagram showing an apex group {P_{A1}_{_{—}}₁, P_{A1}_{_{—}}₂} obtained by orthogonally projecting the apex set {V_{A1}_{_{—}}₁, V_{A1}_{_{—}}₂} shown in FIG. 13A on the contact plane CP.

FIG. 14B is a diagram showing an apex group {P_{B1}_{_{—}}₁, P_{B1}_{_{—}}₂} obtained by orthogonally projecting the apex set {V_{B1}_{_{—}}₁, V_{B1}_{_{—}}₂} shown in FIG. 13B on the contact plane CP.

FIG. 15 is a diagram showing a contact polygon obtained by figuring out a product area of the semi-contact polygons respectively shown in FIGS. 14A and 14B.

FIG. 16A is a diagram showing the condition in which force is applied on each apex of the contact polygon shown in FIG. 15.

FIG. 16B is a diagram showing the condition in which force is applied on each apex of the contact polygon shown in FIG. 15 to execute dynamics simulation in the physical interaction associated with the collision between the object A and the object B.

FIG. 17 is a diagram showing the condition in which the object A and the object B osculate with each other with a plurality of convex segments.

FIG. 18A is a diagram showing a contact plane CP₁ and a pair of collision representative points {P_{A1}, P_{B2}_{_{—}}₁} obtained by the collision detection process between the convex segment B2 and the convex segment A1.

FIG. 18B is a diagram showing a contact plane CP₂ and a pair of collision representative points {P_{A3}, P_{B2}_{_{—}}₁} obtained by the collision detection process between the convex segment B2 and the convex segment A3.

FIG. 19A is a diagram showing {V_{A1}_{_{—}}₁, V_{A1}_{_{—}}₂} existing in the positive area of the contact plane CP₁ obtained by the local search.

FIG. 19B is a diagram showing {V_{B2}_{_{—}}₃, V_{B2}_{_{—}}₄} existing in the positive area of the contact plane CP₁ obtained by the local search.

FIG. 20A is a diagram showing {V_{A3}_{_{—}}₁, V_{A3}_{_{—}}₂} existing in the positive area of the contact plane CP₁ obtained by the local search.

FIG. 20B is a diagram showing {V_{B2}_{_{—}}₁, V_{B2}_{_{—}}₂} existing in the positive area of the contact plane CP₁ obtained by the local search.

FIG. 21A is a diagram showing a boundary apex set {P_{A1}_{_{—}}₁, P_{A1}_{_{—}}₂} of semi-contact polygon obtained by orthogonally projecting the apex set {V_{A1}_{_{—}}₁, V_{A1}_{_{—}}₂} shown in FIG. 19A on the contact plane CP₁, and further executing a two-dimensional convex hull operation on the apex group thus orthogonally projected.

FIG. 21B is a diagram showing a boundary apex set {P_{B2}_{_{—}}₃, P_{B2}_{_{—}}₄} of semi-contact polygon obtained by orthogonally projecting the apex set {V_{B2}_{_{—}}₃, V_{B2}_{_{—}}₄} shown in FIG. 19B on the contact plane CP₁, and further executing a two-dimensional convex hull operation on the apex group thus orthogonally projected.

FIG. 22A is a diagram showing a boundary apex set {P_{A3}_{_{—}}₁, P_{A3}_{_{—}}₂} of semi-contact polygon obtained by orthogonally projecting the apex set {V_{A3}_{_{—}}₁, V_{A3}_{_{—}}₂}, which is extracted as assumed to exist inside the semi-contact polygon, on the contact plane CP₁, and further executing a two-dimensional convex hull operation on the apex group thus orthogonally projected.

FIG. 22B is a diagram showing a boundary apex set {P_{B2}_{_{—}}₁, P_{B2}_{_{—}}₂} of semi-contact polygon obtained by orthogonally projecting the apex set {V_{B2}_{_{—}}₁, V_{B2}_{_{—}}₂}, which is extracted as assumed to exist inside the semi-contact polygon, on the contact plane CP₁, and further executing a two-dimensional convex hull operation on the apex group thus orthogonally projected.

FIG. 23 is a diagram showing an overlapping area obtained by overlapping the semi-contact polygons of the respective convex segments A1 and B2 on the contact plane CP₁.

FIG. 24 is a diagram showing an overlapping area obtained by overlapping the semi-contact polygons of the respective convex segments A3 and B2 on the contact plane CP₁.

FIG. 25A is a diagram showing the condition in which force in a normal line direction of contact planes is applied to each apex of the contact polygons between the convex segment A1 and the convex segment B2, and between the convex segment A3 and the convex segment B2.

FIG. 25B is a diagram showing the condition in which the acting points and acting direction of the force, which is applied to each apex of the contact polygons between convex segment A1 and the convex segment B2, and between the convex segment A3 and the convex segment B2 in a normal line direction of contact planes, are opposed to each other.

FIG. 26A is a diagram showing the condition in which the convex hull A is obtained with respect to the concave object A.

FIG. 26B is a diagram showing the condition in which the convex hull B is obtained with respect to the concave object B.

FIG. 27 is a diagram showing the condition in which a virtual contact plane is determined between the convex hull A and the convex hull B.

FIG. 28A is a diagram showing how the local apex search process is performed using a support point in the convex segment A1 and the convex segment B2, and how an apex set {V_{A1}_{_{—}}₁, V_{A1}_{_{—}}₂} providing the shape of the semi-contact polygon is calculated.

FIG. 28B is a diagram showing how the local apex search process is performed using a support point in the convex segment A1 and the convex segment B2, and how an apex set {V_{B2}_{_{—}}₃, V_{B2}_{_{—}}₄} providing the shape of the semi-contact polygon is calculated.

FIG. 29A is a diagram showing how the local apex search process is performed using a support point in the convex segment A3 and the convex segment B2, and how an apex set {V_{A3}_{_{—}}₁, V_{A3}_{_{—}}₂} providing the shape of the semi-contact polygon is calculated.

FIG. 29B is a diagram showing how the local apex search process is performed using a support point in the convex segment A3 and the convex segment B2, and how an apex set {V_{B2}_{_{—}}₁, V_{B2}_{_{—}}₂} providing the shape of the semi-contact polygon is calculated.

FIG. 30A is a diagram showing a boundary apex set {P_{A1}_{_{—}}₁, P_{A1}_{_{—}}₂} obtained by orthogonally projecting the apex set {V_{A1}_{_{—}}₁, V_{A1}_{_{—}}₂} providing the shape of the semi-contact polygon on the virtual contact plane and executing the two-dimensional convex hull operation on the apex set thus orthogonally projected.

FIG. 30B is a diagram showing a boundary apex set {P_{B2}_{_{—}}₃, P_{B2}_{_{—}}₄} obtained by orthogonally projecting the apex set {V_{B2}_{_{—}}₃, V_{B2}_{_{—}}₄} providing the shape of the semi-contact polygon on the virtual contact plane and executing the two-dimensional convex hull operation on the apex set thus orthogonally projected.

FIG. 31A is a diagram showing a boundary apex set {P_{A3}_{_{—}}₁, P_{A3}_{_{—}}₂} obtained by orthogonally projecting the apex set {V_{A3}_{_{—}}₁, V_{A3}_{_{—}}₂} providing the shape of the semi-contact polygon on the virtual contact plane and executing the two-dimensional convex hull operation on the apex set thus orthogonally projected.

FIG. 31B is a diagram showing a boundary apex set {P_{B2}_{_{—}}₁, P_{B2}_{_{—}}₂} obtained by orthogonally projecting the apex set {V_{B2}_{_{—}}₁, V_{B2}_{_{—}}₂} providing the shape of the semi-contact polygon on the virtual contact plane and executing the two-dimensional convex hull operation on the apex set thus orthogonally projected.

FIG. 32 is a diagram showing an overlapping area {P_{B2}_{_{—}}₃, P_{A1}_{_{—}}₂} obtained by overlapping the boundary apex set {P_{A1}_{_{—}}₁, P_{A1}_{_{—}}₂} shown in FIG. 30A and the boundary apex set {P_{B2}_{_{—}}₃, P_{B2}_{_{—}}₄} shown in FIG. 30B on the virtual contact plane.

FIG. 33 is a diagram showing an overlapping area {P_{A3}_{_{—}}₁, P_{B2}_{_{—}}₂} obtained by overlapping the boundary apex set {P_{A3}_{_{—}}₁, P_{A3}_{_{—}}₂} shown in FIG. 31A and the boundary apex set {P_{B2}_{_{—}}₁, P_{B2}_{_{—}}₂} shown in FIG. 31B on the virtual contact plane.

FIG. 34A is a diagram showing the condition in which force is applied on the boundary apex of the contact polygon of each convex segment.

FIG. 34B is a diagram showing how the penetration problem between the objects including the convex segment complex is solved by applying the force to the boundary apex of the contact polygon of each convex segment.

FIG. 35 is a diagram schematically showing the functional configuration of a contact geometry calculation device for calculating the contact polygon formed between the objects with an arbitrary shape including a concave shape.

FIG. 36 is a flowchart showing a procedure of the contact polygon determination process performed by a contact geometry calculation device 1.

FIG. 37 is a flowchart showing a detailed procedure of the virtual contact plane determination process.

FIG. 38 is a flowchart showing a detailed procedure of the inter-convex segment contact polygon determination process.

FIG. 39 is a flowchart showing a detailed procedure of the local search process of each convex segment in the inter-convex segment contact polygon determination process.

FIG. 40 is a flowchart showing a detailed procedure of the apex search process executed in the step S37 of the flowchart shown in FIG. 39.

FIG. 41 is a diagram for explaining a method of interference detection and of solving the contact problem using a non-penetration model with a convex hull of the object expanded by the radius r of the sphere.

FIG. 42 is a diagram showing the osculating shape formed while the two cubes A and B are contiguous with each other.

FIG. 43 is a diagram showing one representative point for every one collision between the two solid bodies obtained by a well-known collision detection algorithm.

FIG. 44 is a diagram showing a triangle mesh causing a collision between the two solid bodies obtained by a well-known collision detection algorithm.

FIGS. 45A and 45B are diagrams showing the conditions in which the reaction force is made act only on the representative point P (in the case in which the floor reaction force model does not have the restoring force, and in the case in which the floor reaction force model has the restoring force, respectively) in the case in which the solid body is put on a horizontal floor.

FIG. 46A is a diagram showing a pair of the nearest neighbors between the two objects obtained by a nearest neighbor calculation process.

FIG. 46B is a diagram showing a pair of the most penetrating points between the two objects obtained by a most penetrating point calculation process.

### DESCRIPTION OF THE EMBODIMENTS

Hereinafter, embodiments of the invention will be explained in detail with reference to the accompanying drawings.

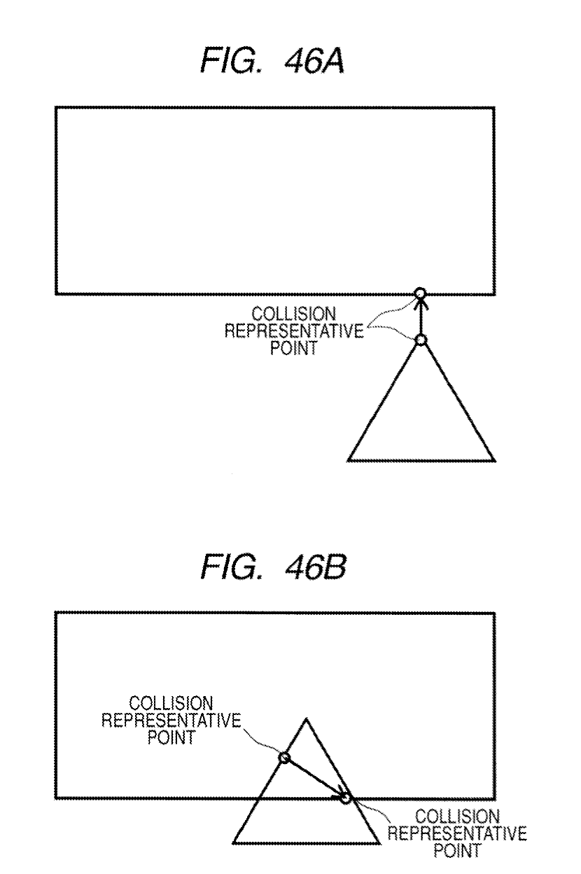

The present invention relates to a contact polygon calculation method for obtaining fast the contact polygon formed between the objects with arbitrary shapes including not only a convex shape but also a concave shape under the circumstances in which a collision or a contact occurs. In the invention, a collision detection algorithm in the related art can be adopted for the osculation detection between objects. Here, as the collision detection algorithm, the Gilbert-Johnson-Keerthi distance algorithm (GJK) is assumed. The GJK algorithm is a repetitive method for calculating a distance between convex figures, wherein a pair of collision representative points (a pair of the nearest neighbors or a pair of the most penetrating points) is output as an interference detection result. FIGS. 46A and 46B show schematic diagrams of the GJK algorithm. FIG. 46A describes the nearest neighbor calculation process, and FIG. 46B describes the most penetrating point calculation process. Although in the drawings two-dimensional space expression is used for the sake of simplification, it should sufficiently be understood that it can be effective in the three-dimensional space.

For further details about the GJK algorithm, see also, for example, G. van den Bergen, “A Fast and Robust GJK implementation for Collision Detection of Convex Objects” (Journal of Graphics Tools, 4(2), pp. 7-25, 2001).

It should be noted, however, that the algorithms for respectively calculating the nearest neighbor and the most penetrating point, and the purpose of use therefor is different. Specifically, if the objects do not penetrate each other, the GJK distance algorithm is used as the nearest neighbor calculation algorithm, and if the objects penetrate each other, an expanding polytope algorithm (EPA) is used as the most penetrating point calculation algorithm. In the present specification, unless otherwise noted, the algorithms for calculating the nearest neighbor or the most penetrating point are treated with a collective name of the GJK algorithm.

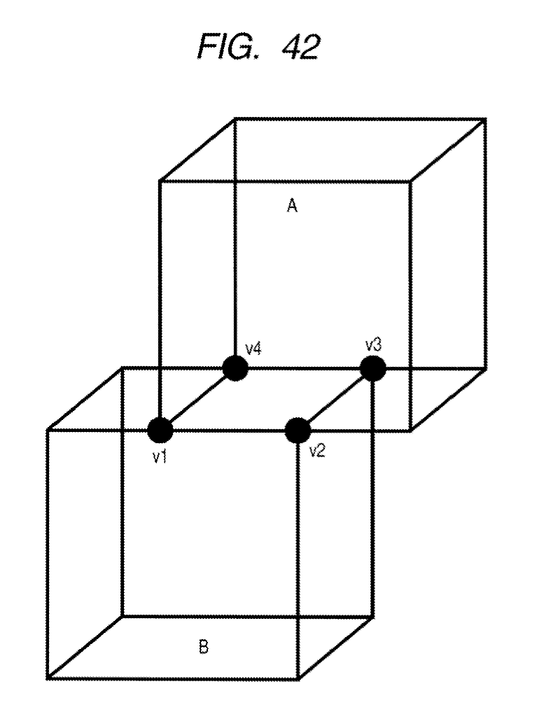

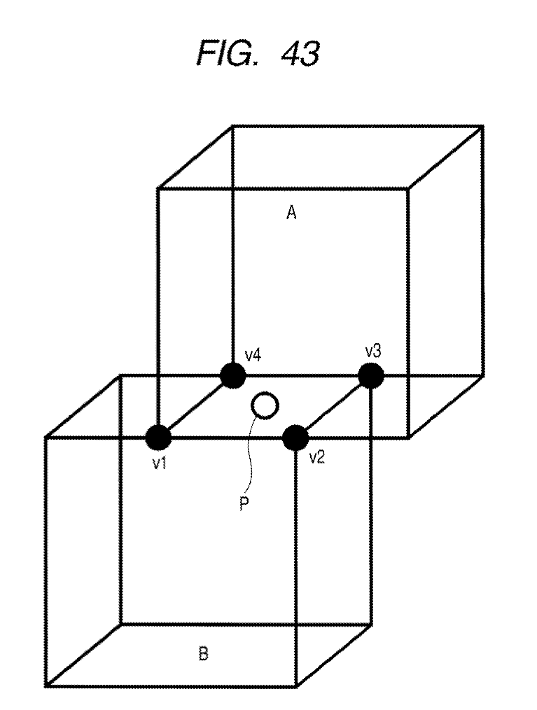

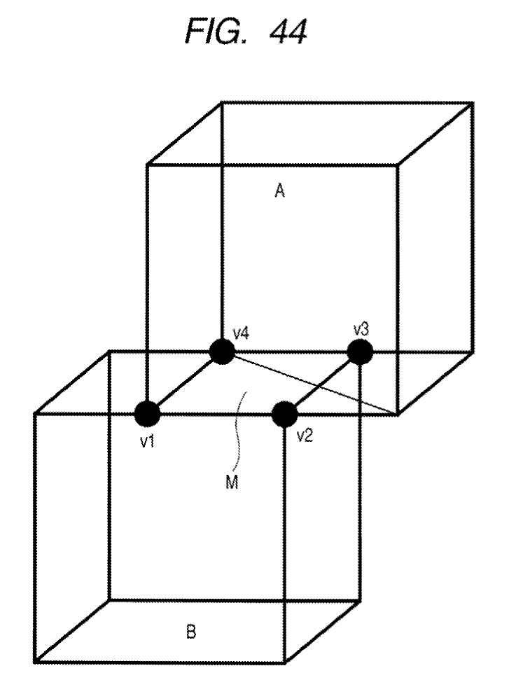

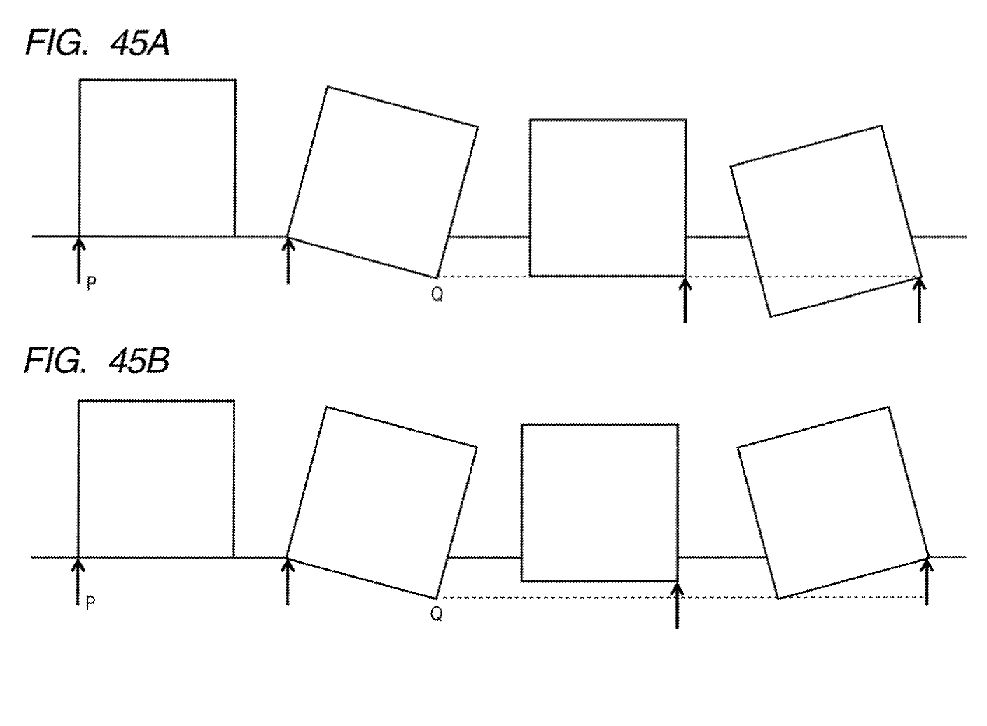

Although the present invention relates to calculation of the contact polygon between the objects with arbitrary shapes including not only a convex shape but also a concave shape, the calculation method of the contact polygon formed between the objects with convex shapes is firstly explained. For simplification, as shown in FIG. 42, in the case in which the two solid bodies A and B interfere with each other, the method of obtaining the contact polygon (v1, v2, v3, v4) will be explained on a specific example.

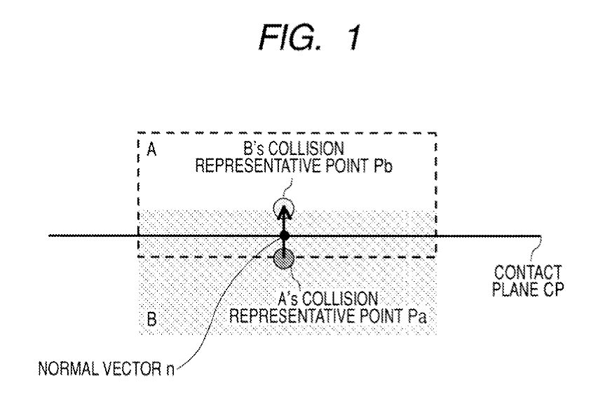

FIG. 1 shows an enlarged view from the side of the calculating section between the objects A and B. It is assumed that a pair of representative points (i.e., a pair of points penetrating the most deeply with each other) Pa and Pb causing a contact between the two objects in a contact condition is calculated by the collision detection algorithm described above. In the contact geometry calculation method according to an embodiment of the invention, all apexes v1, v2, v3, and v4 forming the contact polygon are obtained using the information regarding this pair of collision representative points as a starting point.

As the first step of finding out the contact state, a normal vector n in the osculating section between the objects A and B is provided. It is known that the normal vector n can normally be well approximated as a unit vector connecting the collision representative points Pa and Pb, and the normal vector n can be obtained by the following formula (1).
n=(P_{b}−Pₐ)/|P_{b}−Pₐ| (1)

Further, a plane CP passing through the midpoint of the segment connecting the pair of collision representative points Pa and Pb, and having the normal vector of n is defined and is called as “a contact plane.”

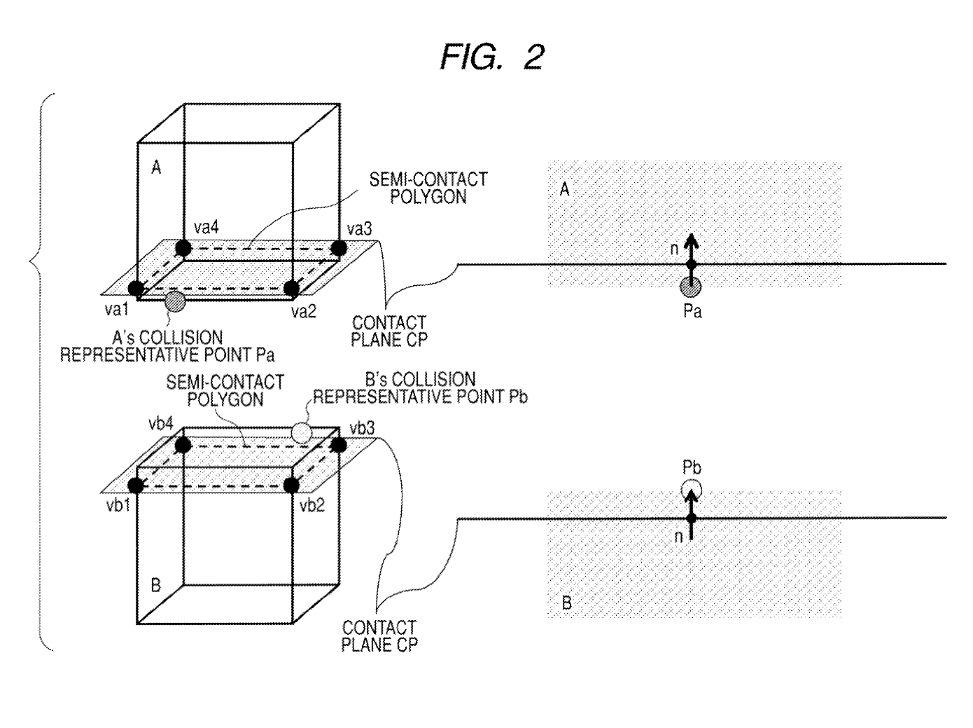

If the contact condition between the objects A and B is treated directly, various combinations exist, and accordingly, the problem becomes more complicated. Therefore, as the second step for finding out the contact condition between the objects, as shown in FIG. 2, by dividing this problem into two independent problems, the contact problem between the contact plane CP and one object A and the contact problem between the contact plane CP and the object B, the complicated combination problems caused when treating this problem intuitively are avoided, and the contact condition is obtained efficiently.

Further, regarding the understanding of the contact condition between a plane and a convex object, the shape of the contact plane can be obtained with relative ease by a process such as searching all of the apexes of the object existing on the plane. Specifically, as shown in FIG. 2, the principle for obtaining the apex set (va1, va2, va3, va4) and the apex set (vb1, vb2, vb3, vb4) providing the shape of the contact surface to each of the object with the contact plane is easily configured. In the present specification, a polygon providing the contact geometry between each of the object A and the object Band the contact plane CP should be called as “a semi-contact polygon.”

By performing a search regarding whether or not the apex exists on the contact plane with respect to each of all the apexes of respective objects A and B, the semi-contact polygon can be obtained (see also, e.g., Franco P. Preparata, Michael Ian Shamos, “Computational Geometry An Introduction” (Springer-Verlag GmbH & Co. KG., 1990)). However, if such an exhaustive search of the apexes is performed, the amount of calculation necessary for the apex search becomes large as the number of apexes of the object increases. It is not desirable that the speed of calculating the contact polygon is lowered as the shape thereof becomes complicated because it causes a bottleneck of the real-time processing in both of the dynamics simulation and the application to the robot control.

Therefore, in the present embodiment, it is decided to adopt a method for obtaining the semi-contact polygon fast and with few amount of calculation by only performing the local search. In the collision detection algorithm GJK implemented to be efficient, there is held in addition to the information of the collision representative points Pa and Pb of each object, a graph (i.e., an adjacent apex graph) for representing the connection relationships among the apexes of each of the peripheral objects A and B. An appropriate origin on the adjacent apex graph is calculated from the Pa and Pb, and only a part of apexes on the adjacent apex graph is searched using the origin to configure the semi-contact polygon.

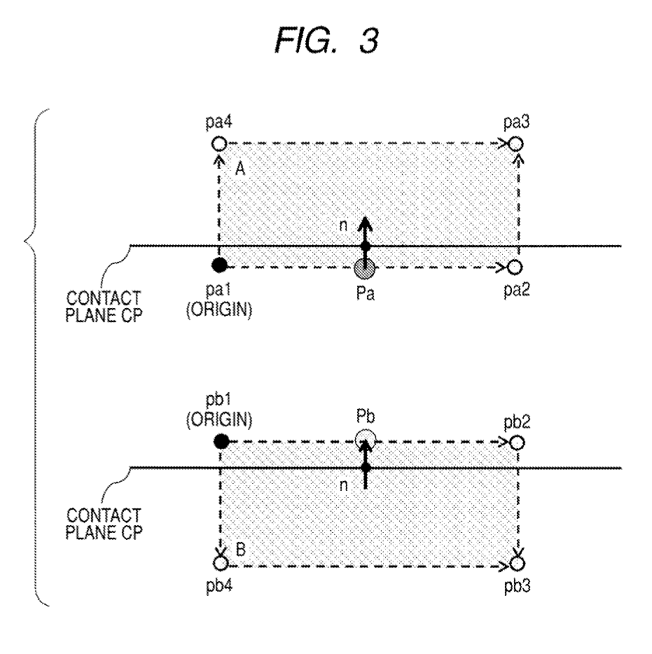

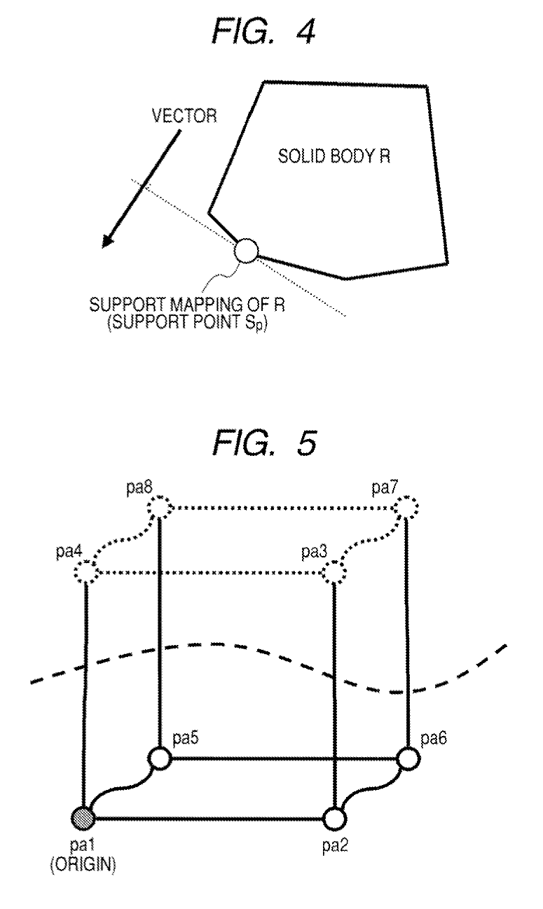

As shown in FIG. 3, the representative points Pa and Pb obtained from the respective objects by the collision detection algorithm do not necessarily exist on the apex of the respective objects A and B. Therefore, although it is necessary to firstly calculate appropriate origin on the adjacent apex graph from the representative points Pa and Pb, in this regard, by calculating the support mapping to the direction of the normal vector n (or inverse −n thereof) with respect to each of the objects A, B, as a result, the support point Sₚ can be obtained. The support mapping denotes an operation for obtaining an apex (a support point) the remotest in a certain vector direction of all the apexes of an object. FIG. 4 shows how the support mapping to the vector direction illustrated with an arrow is obtained with respect to a certain object R. In the example shown in FIG. 3, the support mapping of the solid body A in the inverse direction of the normal vector becomes, for example, pa1. Further, the support mapping of the solid body B in the normal vector direction becomes, for example, pb1. Thus, these points obtained by the support mapping can be the origins for the adjacent apex graph search of the respective solid bodies A, B.

The support mapping is also used inside the collision detection algorithm (GJK). Therefore, by using a halfway result of the collision detection calculation, the support mapping in the normal vector direction described above can be obtained fast. It should be noted that since the calculation method of the support mapping itself is not the subject matter of the embodiment of the invention, for further details, the document G. van den Bergen, “A fast and Robust GJK implementation for Collision Detection of Convex Objects” (Journal of Graphics Tools, 4(2), pp. 7-25, 2001) should be referred to.

Subsequently, using the apexes (support points) obtained from the support mapping the normal vector (or the inverse thereof) direction as the origins, the search on the adjacent apex graph of the respective objects A and B is performed. In explaining with reference to FIG. 5, whether or not the origin pa1 is disposed below the contact plane CP is firstly examined. If it is disposed below, the apex pa1 can be judged as the point existing inside the semi-contact polygon. In this case, whether a certain apex x is disposed in the positive area on a certain plane (a plane passes through the normal vectors n, p) or in the negative area thereon can be judged using the following formula (2).
Assuming f(x)=n·(x−p)
If f(x)>0, then positive area, otherwise negative area. (2)

Then, regarding also the apexes pa2 and pa4 adjacent to pa1, whether or not they exist below the contact plane is examined by the same method. The positional relationships between the contact plane and the apexes are examined while thus tracing the adjacent apex graph recursively. Then, if the apex, which has already been searched, or the apex, which exists above the contact plane, is reached, there is no need to trace the adjacent apex graph any further. The set of the apexes existing below the contact plane and obtained before that time provides the set of the points on the periphery of the semi-contact polygon and the points inside the semi-contact polygon.

As described above, according to the local search of the adjacent apex graph using the apexes obtained from the support mapping in the direction of the normal vector (or the inverse thereof) as origins, since the search is performed only on the apexes existing below the contact plane in the adjacent apex graph, the search on the very few apexes is only required, and accordingly, a dramatic improvement in the calculation speed can be achieved compared to the method of performing exhaustive search of the apexes of the object.

In the example shown in FIG. 5, the four points pa1, pa2, pa5, and pa6 on or below the broken line are finally obtained as the semi-contact polygon for providing the contact geometry between the object A and the contact plane. Further, it should fully be understood that even if the object A, which is the target of the process, has a further complicated shape and has an apex above the apexes pa3, pa4, pa7, and pa8, by performing the local search of the adjacent apex graph using an appropriate apex as the origin along with the algorithm described above, the search does not proceed to any further range.

Further, regarding the semi-contact polygon between the object B and the contact plane CP as the other contact problem, similarly to the above, by tracing the adjacent apex graph recursively form the origin of pb1 until the apex existing below the contact plane after obtaining the nearest apex pb1 to the representative point Pb by the support mapping in the normal line direction, the apex set existing above the contact plane CP can be obtained only by the local search.

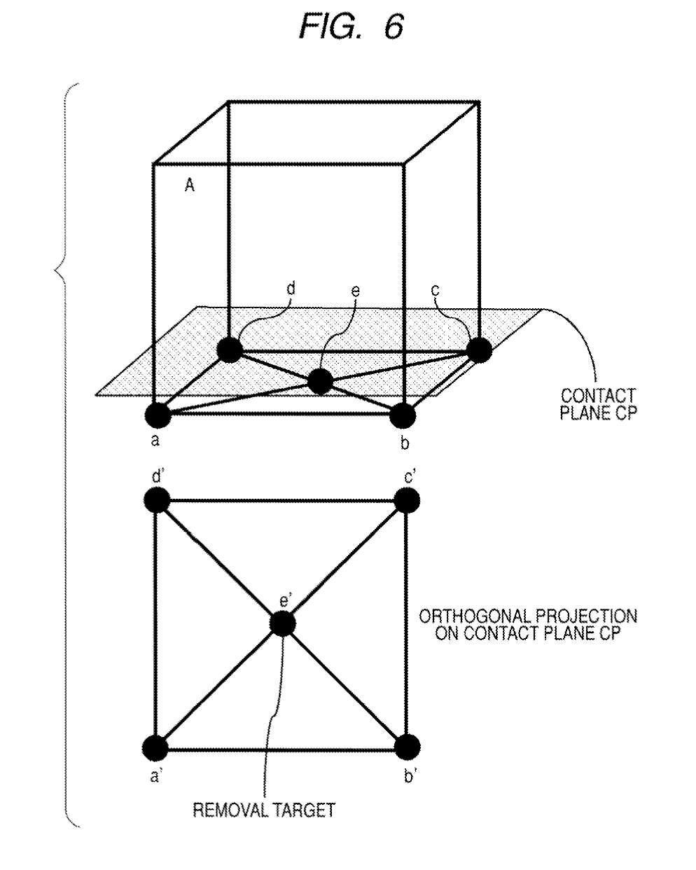

The apex set obtained by searching on the adjacent apex graph along the procedure described above also includes a point existing inside the semi-contact polygon in general. For example, as shown in FIG. 6, in the case in which only one additional apex e is set at the center of the side besides the apexes a, b, c, and d forming a polygon as a face of an object, if the face becomes the contact plane, the apex set obtained as a result of the apex search described above includes five points of (a, b, c, d, and e), which includes the point e inside the semi-contact polygon, and accordingly, becomes redundant.

In the present embodiment, as the third step for finding out the contact condition between the objects, it is arranged to remove such a point inside the semi-contact polygon from the search result. Specifically, the apex set extracted as existing inside the semi-contact polygon is orthogonally projected on the contact plane CP, and the two-dimensional convex hull operation is executed on the orthogonally projected apex group (a0, b0, c0, d0, e0). The convex hull operation here is an operation for obtaining the minimum convex polygon apex set including the apex set, and Graham's method and so on can be used therefor. Regarding Graham's method, see also the document Ronald Graham, “An Efficient Algorithm for Determining the Convex Hull of a Finite Planar Set” (Info. Proc. Letters, 1, pp. 132-133, 1972).

As a result of thus performing the process for removing the point inside the semi-contact polygon from the apex set, in the example shown in FIG. 6, the contour (a′, b′, c′, d′) of the semi-contact polygon from which the apex e′ is removed, and not including the inside point can be obtained. In the similar way, between the object B and the contact plane CP, the boundary apex set (i.e., contour apex set) of the semi-contact polygon not including the inside point on the contact plane is previously calculated.

Then, finally, the semi-contact polygons of the respective objects A and B thus obtained along the procedure described above are overlapped on the contact plane, and an overlapping area (an intersection area, a product area) is obtained. The overlapping area provides the contact polygon between the two objects.

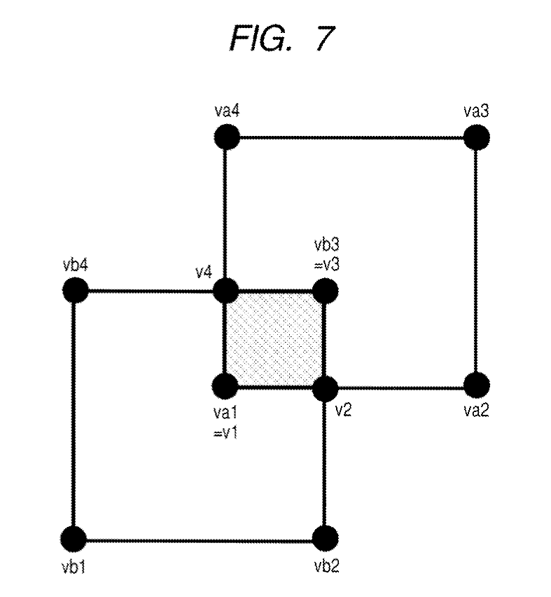

In the example shown in FIG. 2, the semi-contact polygons of the respective objects A and B in the contact plane become (va1, va2, va3, va4) and (vb1, vb2, vb3, vb4), respectively, as shown in FIG. 7. Therefore, the overlapping area becomes (v1, v2, v3, v4).

It should be noted that in order for efficiently obtaining the overlapping area between two two-dimensional polygons, for example, the method described in the document, O'Rouke, et. al, “A new linear algorithm for intersecting convex polygons” (Comput. Graph. Image Process., 19, pp. 384-391, 1982) can be used.

Regarding the contact polygon calculation method for obtaining fast the contact polygon formed between the object having convex shapes, there are detailed explanations also in the specification of Japanese Patent Application No. 2005-289598, which has already been assigned to the assignee of the present patent application.

Subsequently, the calculation method of the contact polygon formed between the objects including a concave shape will be explained.

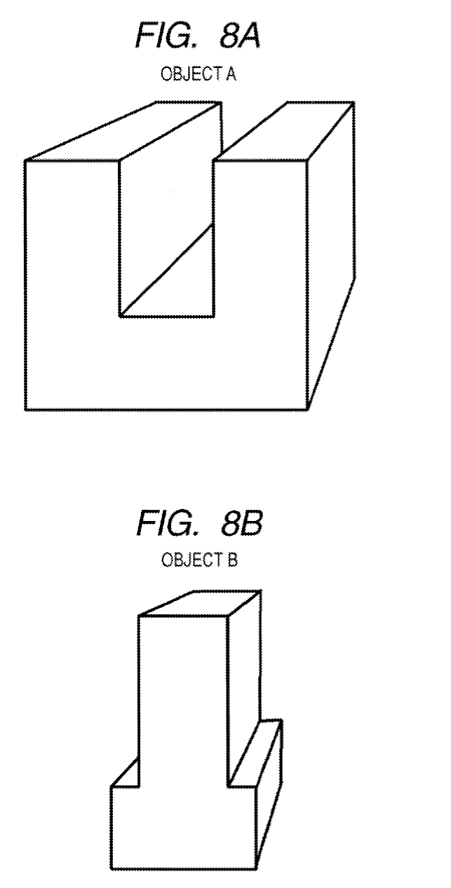

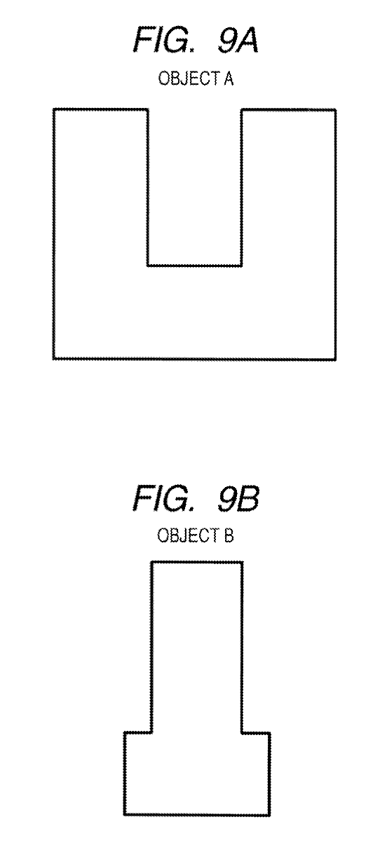

Regarding the two objects A and B having concave shape as shown in FIGS. 8A and 8B, various contact conditions are assumed. FIGS. 9A and 9B respectively show two-dimensional expressions of the respective three-dimensional objects shown in FIGS. 8A and 8B.

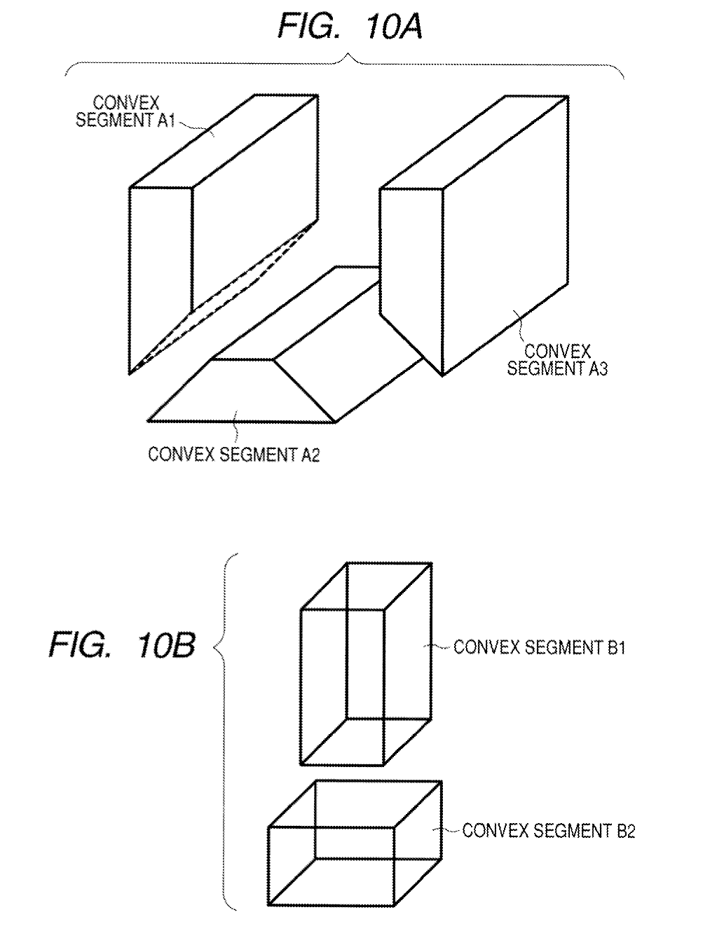

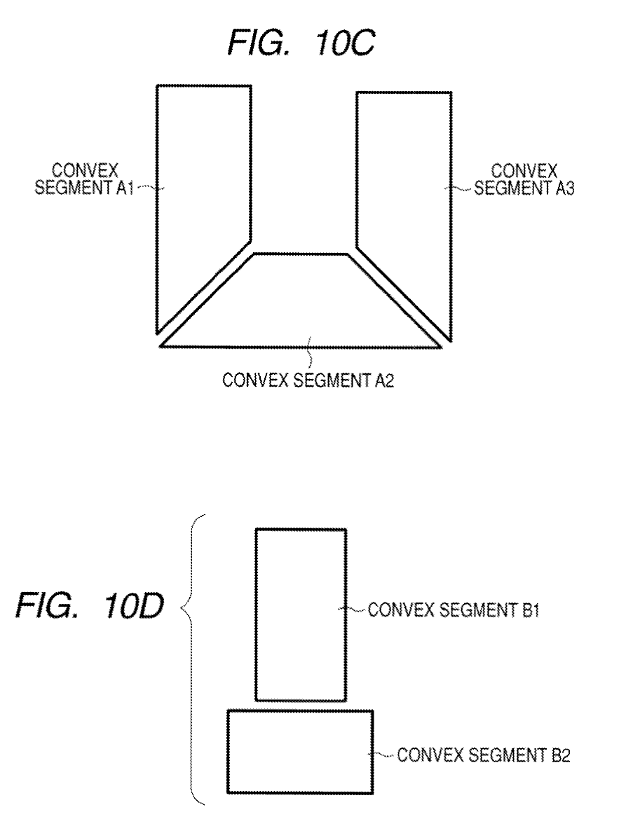

If the object, on which the collision detection performed, has a convex shape, the judgment can be executed faster compared to the case in which it has a concave shape (see e.g., C. Ericson, “Real-Time Collision Detection” (Morgan Kaufmann Publishers, 2005)). Therefore, also in the present embodiment, the algorithm efficient for the convex object is used for collision detection between concave objects. Specifically, the concave polyhedrons not convex as shown in FIGS. 8A, 8B, 9A, and 9B are convex-decomposed into a plurality of convex segments, and the concave object is treated as a complex (hereinafter referred to as “convex segment complex”) composed of a plurality of convex segments. Specifically, the object A shown in FIGS. 8A and 9A is treated as a complex of the three convex segments A1, A2, and A3 shown in FIGS. 10A and 10C, and the object B shown in FIGS. 8B and 9B is treated as a complex of the two convex segments B1, B2 as shown in FIGS. 10B and 10D.

It should be noted that the subject matter of the embodiment of the invention is not limited to a specific convex-decomposition algorithm. Regarding details of the convex-decomposition algorithm, see also documents such as Belov, Gleb, “A Modified Algorithm for Convex Decomposition of 3D Polyhedra” (Technical report MATH-NM-03-2002, Institute for Numerische Mathematik, Techniche Universitat, Dresden. March 2002), Lu, Youg. RajitGdh, “Constrained and Aggregated Half Space Volume Decomposition: Generating Cutting Patches with ‘Internal’ and ‘External’ Extending” (Proceedings of the Eighth Pacific Conference on Computer Graphics and Applications (PG 00), pp. 262-271, 2000), Staphen A. Ehmann and Ming C. Lin, “Accurate and Fast Proximity Querues Between Polyhedra using Convex Surface Decomposition” (EUROGRAPHICS 2001).

Actual convex-decomposition algorithm for a concave polyhedron causes a very heavy load, and accordingly, a real-time execution in the dynamics simulation is difficult. Therefore, it is possible to take a from that the convex-decomposition is performed on the locomotive robot or the concave object existing under an environment as a preprocessing before performing the simulation, the calculation results such as the shape data such as a face, a line, an apex of the obtained convex segment, or connection information between the convex segments are held in a predetermined file format, and then the files are retrieved when performing the simulation according to needs.

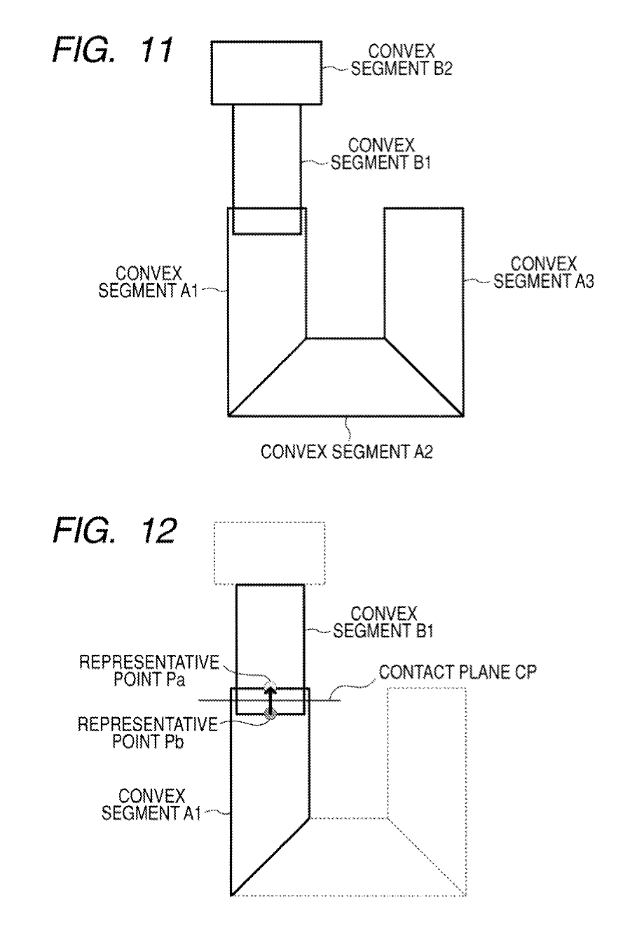

Here, the case in which the object A and the object B cause a collision in a manner shown in FIG. 11 will be considered. As described above, in the case in which the object A is treated as a convex segment complex composed of the convex segments A1 through A3, and the object B is treated as a convex segment complex composed of the convex segments B1 and B2, a collision is caused between the convex segments A1 and B1. In this case, as shown in FIG. 12, only the interference detection process (contact polygon calculation process) described above between the convex segments A1 and B1 needs to be performed. Specifically, as the first step, the contact plane CP in the contact region between the object A and the object B is calculated. Firstly, the collision representative points Pa and Pb of the respective convex segments A1 and B1 in a contact condition are calculated by the collision detection algorithm, and the normal vector n connecting the collision representative points Pa and Pb is obtained. Then, using the normal vector n as a normal line, the contact plane CP passing through the midpoint of the collision representative points Pa and Pb is obtained.

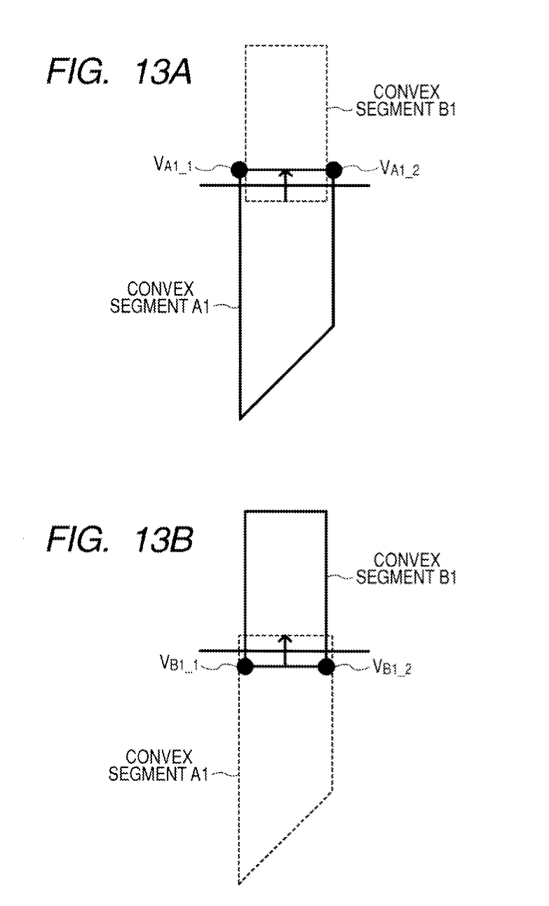

As the subsequent second step, it is divided into two independent problems, namely the contact problem between the contact plane CP and the convex segment A1 and the contact problem between the contact plane CP and the convex segment B1, and in the respective problems, semi-contact polygons composed respectively of the apex sets {V_{A1}_{_{—}}₁, V_{A1}_{_{—}}₂} and {V_{B1}_{_{—}}₁, V_{B1}_{_{—}}₂} for providing contact geometries are calculated. FIGS. 13A and 13B respectively show the sets {V_{A1}_{_{—}}₁, V_{A1}_{_{—}}₂} and {V_{B1}_{_{—}}₁, V_{B1}_{_{—}}₂} existing in the positive area of the contact plane CP obtained by the local search.

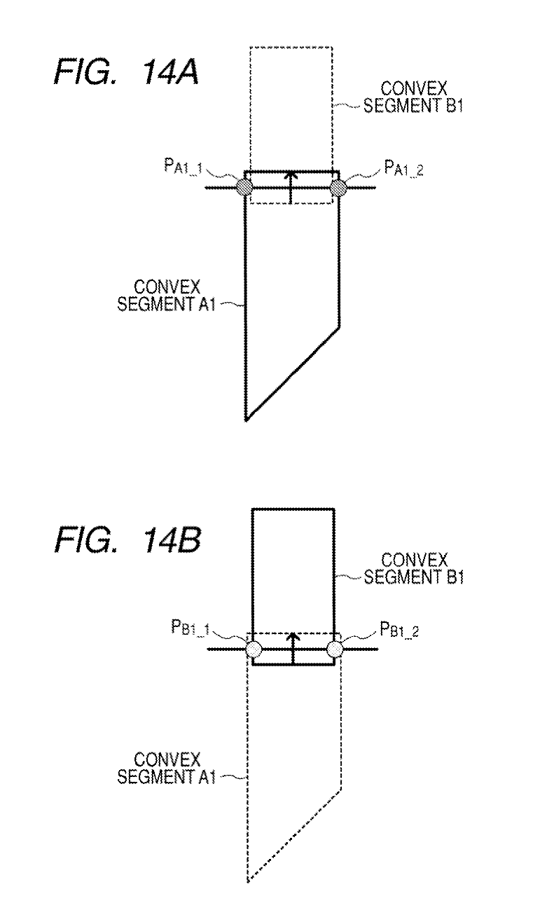

As the subsequent third step, the respective apex sets {V_{A1}_{_{—}}₁, V_{A1}_{_{—}}₂} and {V_{B1}_{_{—}}₁, V_{B1}_{_{—}}₂} extracted as existing inside the semi-contact polygons are orthogonally projected on the contact plane CP, and the two-dimensional convex hull operation is executed on the apex groups orthogonally projected using the Graham's method or the like, thus obtaining the minimum convex polygon apex set including the apex set. FIGS. 14A and 14B respectively show apex groups {P_{A1}_{_{—}}₁, P_{A1}_{_{—}}₂} and {P_{B1}_{_{—}}₁, P_{B1}_{_{—}}₂} obtained by orthogonally projecting the apex sets {V_{A1}_{_{—}}₁, V_{A1}_{_{—}}₂} and {V_{B1}_{_{—}}₁, P_{B1}_{_{—}}₂} shown in FIGS. 13A and 13B on the contact plane CP. By executing the two-dimensional convex hull operation on the apex groups {P_{A1}_{_{—}}₁, P_{A1}_{_{—}}₂} and {P_{B1}_{_{—}}₁, P_{B1}_{_{—}}₂} orthogonally projected on the contact plane CP, the boundary apex sets (i.e., the contour apex sets) of the semi-contact polygons can be obtained.

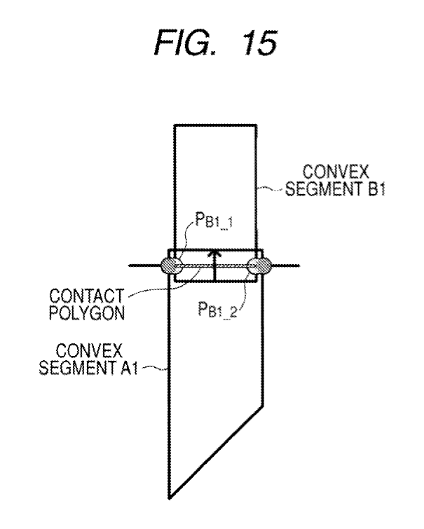

Then, as the last step, the respective semi-contact polygons of the respective convex segments A1 and B1 obtained by the process hereinabove are overlapped on the contact planes CP to obtain the overlapping area (intersection area, product area). The overlapping area provides the contact polygon between these convex segments. FIG. 15 shows a contact polygon obtained by figuring out a product area of the semi-contact polygons respectively shown in FIGS. 14A and 14B. In the example shown in the drawing, the contour apex set {P_{B1}_{_{—}}₁, P_{B1}_{_{—}}₂} shown in FIG. 14B becomes the contact polygon between the objects A and B.

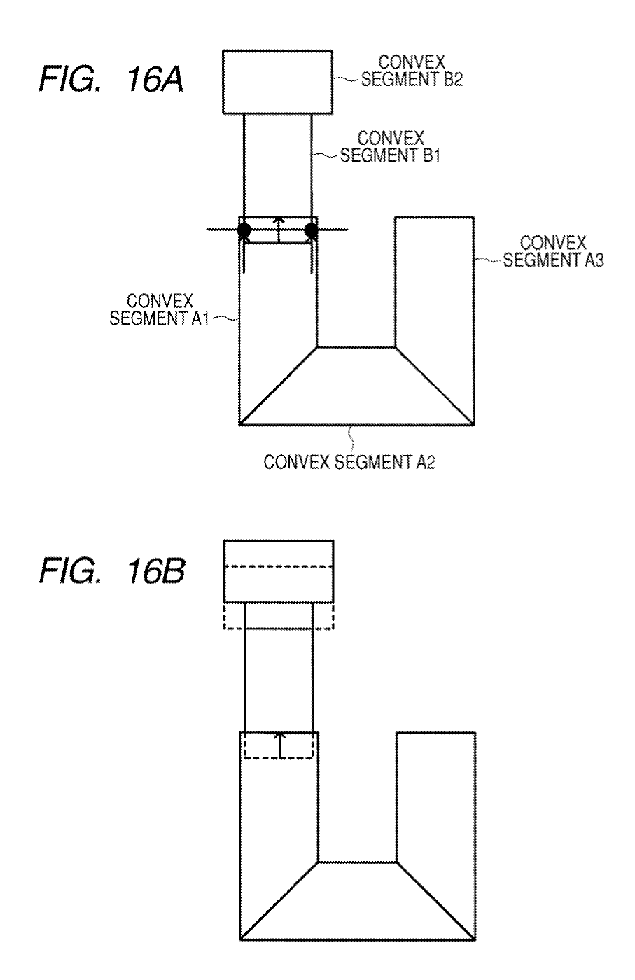

By applying force (e.g., reaction force or restoring force to the contact) to each apex of the contact polygon calculated above (see FIG. 16A), a preferable dynamics simulation in the physical interaction caused by the contact between the object A and the object B can be performed (see FIG. 16B).

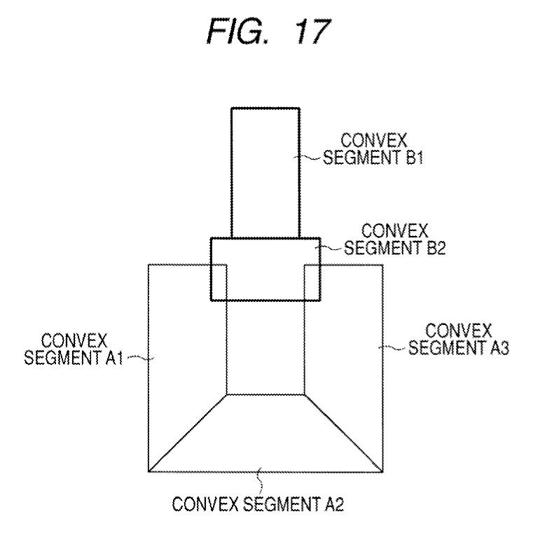

Hereinabove, the calculation process of the contact polygon in the example in which the objects A and B osculate with one convex segment each has been explained. Then, the case in which contacts are caused between concave objects with a plurality of convex segments as shown in FIG. 17 will be considered. In the example shown in the drawing, the collisions are caused between the convex segment B2 and the convex segment A1, and between the convex segment B2 and the convex segment A3.

Firstly, similarly to the example described above, it is assumed that the collision detection process and the contact polygon calculation process are performed independently for each combination of the convex segments causing a contact.

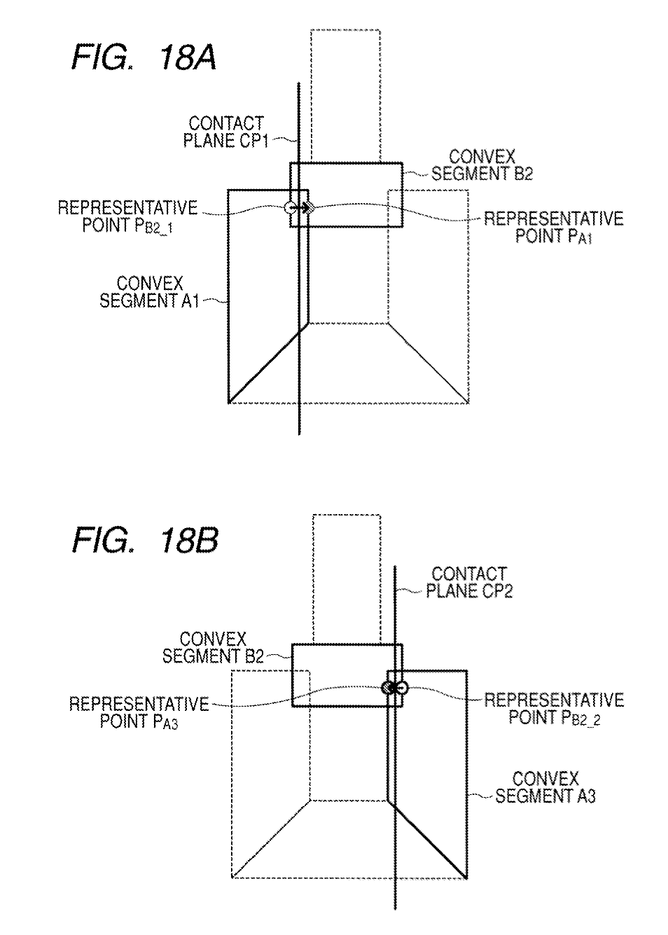

In this case, in the first step, a pair of collision representative points {P_{A1}_{_{—}}₁, P_{b1}_{_{—}}₁} is obtained by the collision detection process between the convex segments B2 and A1, and the contact plane CP1 is calculated based thereon (see FIG. 18A). Similarly, a pair of collision representative points {P_{A3}, P_{B2}_{_{—}}₁} is obtained by the collision detection process between the convex segments B2 and A3, and the contact plane CP2 is calculated based thereon (see FIG. 18B).

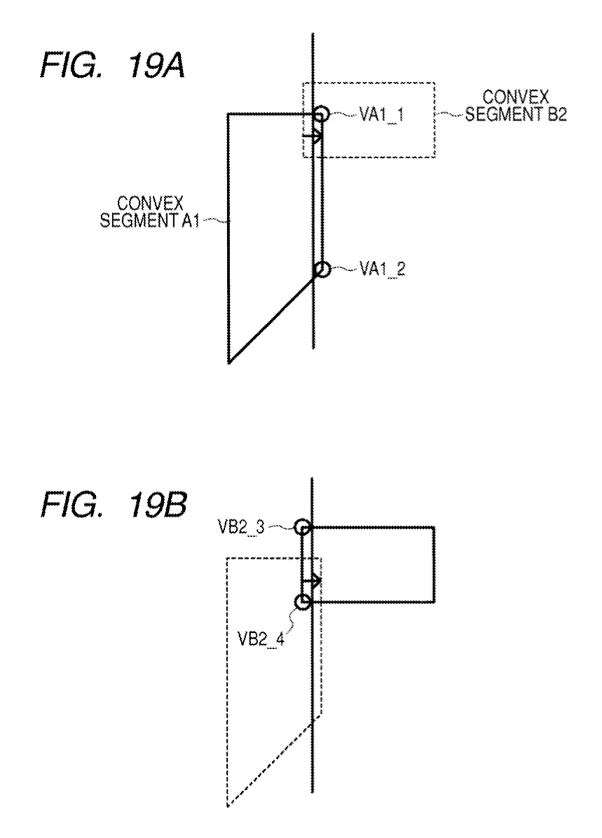

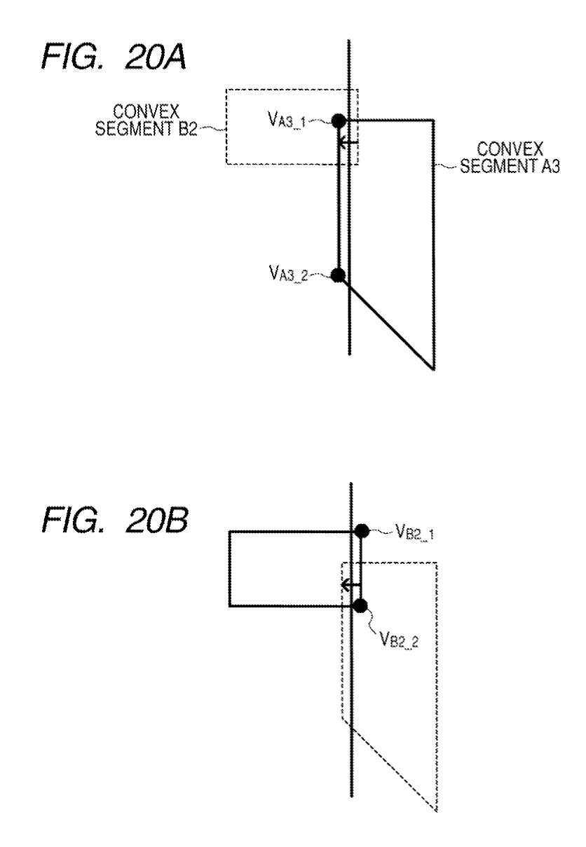

In the subsequent second step, the contact plane CP1 is used as a judgment condition for independently solving the contact problems of the convex segment A1 and the convex segment B2 to calculate the semi-contact polygons composed of the apex sets of {V_{A1}_{_{—}}₁, V_{A1}_{_{—}}₂} and {V_{B2}_{_{—}}₃, V_{B2}_{_{—}}₄} providing the contact geometries, respectively (see FIGS. 19A and 19B). Similarly, the contact plane CP1 is used as a judgment condition for independently solving the contact problems of the convex segment A3 and the convex segment B2 to calculate the semi-contact polygons composed of the apex sets of {V_{A3}_{_{—}}₁, V_{A3}_{_{—}}₂} and {V_{B2}_{_{—}}₁, V_{B2}_{_{—}}₂} providing the contact geometries, respectively (see FIGS. 20A and 20B).

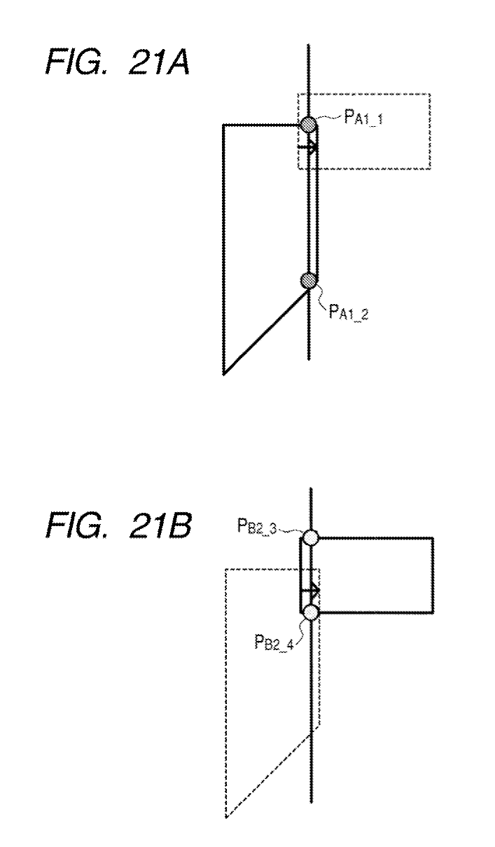

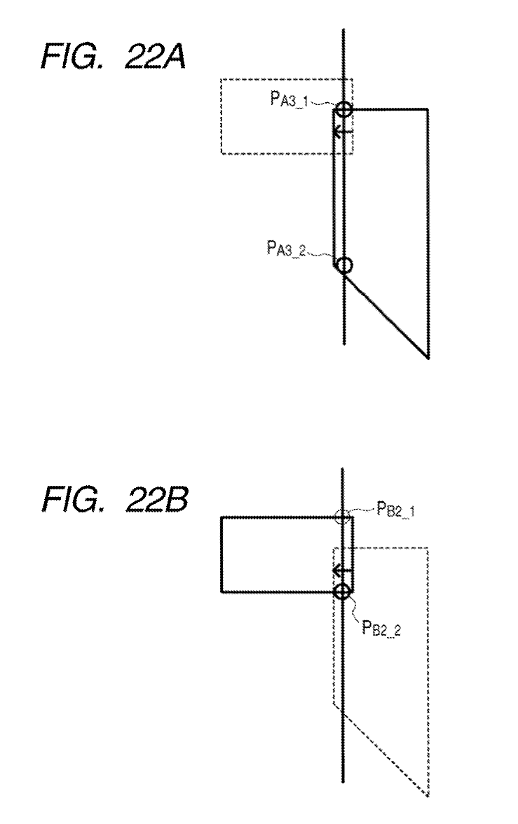

In the subsequent third step, the respective apex sets {V_{A1}_{_{—}}₁, V_{A1}_{_{—}}₂} and {V_{B2}_{_{—}}₃, V_{B2}_{_{—}}₄} extracted as existing inside the semi-contact polygons are orthogonally projected on the contact plane CP1, and the two-dimensional convex hull operation is further performed on the orthogonally projected apex groups to respectively obtain the boundary apex sets {P_{A1}_{_{—}}₁, P_{A1}_{_{—}}₂} and {P_{B2}_{_{—}}₃, P_{B2}_{_{—}}₄} of the semi-contact polygons (see FIGS. 21A and 21B). Similarly, the respective apex sets {V_{A3}_{_{—}}₁, V_{A3}_{_{—}}₂} and {V_{B2}_{_{—}}₁, V_{B2}_{_{—}}₂} extracted as existing inside the semi-contact polygons are orthogonally projected on the contact plane CP1, and the two-dimensional convex hull operation is further performed on the orthogonally projected apex groups to respectively obtain the boundary apex sets {P_{A3}_{_{—}}₁, P_{A3}_{_{—}}₂} and {P_{B2}_{_{—}}₁, P_{B2}_{_{—}}₂} of the semi-contact polygons (see FIGS. 22A and 22B).

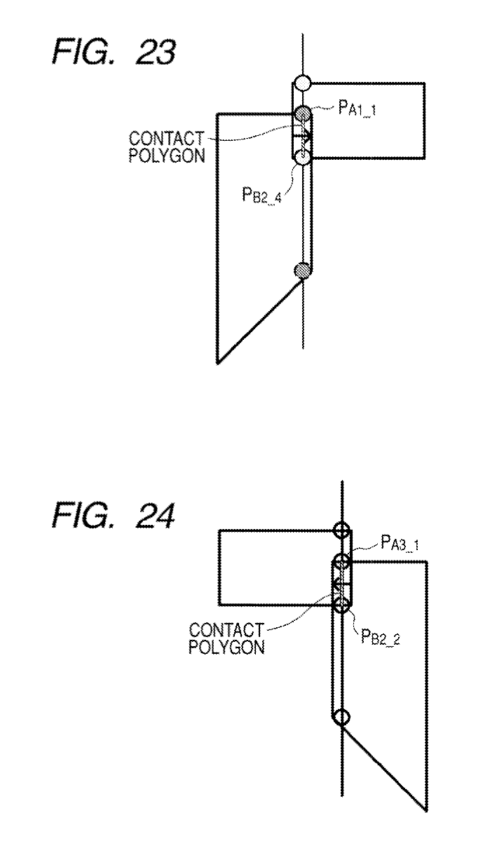

Further, in the last step, the semi-contact polygons of the respective convex segments A1 and B2 are overlapped on the contact plane CP1 to obtain the overlapping area (see FIG. 23), and at the same time, the semi-contact polygons of the respective convex segments A3 and B2 are overlapped on the contact plane CP2 to obtain the overlapping area (see FIG. 24).

The contact polygons shown in FIGS. 23 and 24 can preferably be used in the simulation in view of the calculation results for every convex segment, but are problematical for performing a simulation as the convex segment complex, namely as the original objects of A and B.

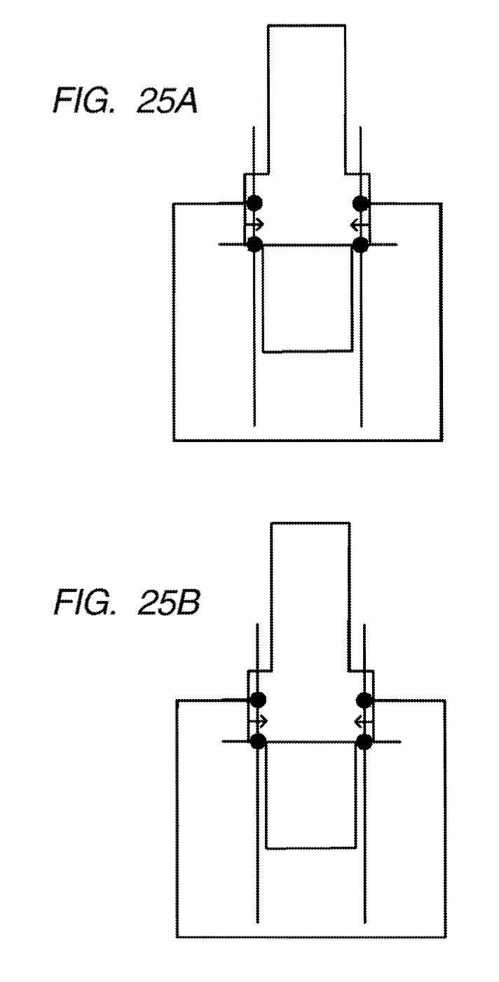

As shown in FIG. 25A, when the force is applied to each apex of the contact polygon between the convex segments A1 and B2, and the contact polygon between the convex segments A3 and B2 in the normal line direction of the contact plane, the acting points and the acting directions are opposed to each other, and accordingly, the penetration of the objects A and B should be canceled. This is unexpected result, and the state shown in FIG. 25B appears, in other words, the state in which the object B penetrates inside the bracket shape formed by the object A remains unsolved, or at worst, a vibration is caused to prevent obtaining a preferably simulation result. Such a result derives from lace of consideration of direction in which the penetration is eliminated in the penetration elimination problem between the convex segment complex (the concave objects).

Therefore, the inventor of the present invention conceived of that the definition of elimination of penetration between objects in dealing with the collision detection problem including a concave object needs to be newly redefined separately from what is used in the collision detection problem between convex objects.

In general, in the collision detection problem between the convex objects, the elimination of penetration (penetration depth) between geometric objects is defined as follows (see e.g., Gino van den Bergen, “Collision Detection in Interactive 3D Environments” (Morgan Kaufmann Publishers, 2003)).

“Penetration depth” is defined as the global minimum vector necessary for canceling the penetration between convex objects. Note that φ denotes an empty set.
min{||d|||Interior(A+d)∩B=φ} (3)

In contrast, in the present embodiment, without limiting the objects A and B, the targets of collision detection, to the convex objects, a definition applicable to the concave objects will be introduced.

The definition says that it is the global minimum vector necessary for canceling the penetration between objects with arbitrary shapes including a concave shape. Note that “conv()” denotes a convex hull of a point set of the object A.
min{||d|||Interior(conv(A)+d)∩conv(B)=φ} (4)

In the present specification, the vector d of the above formula 4 will be called “virtual penetration depth vector.” By setting an appropriate direction for eliminating the penetration using the virtual penetration depth vector, the penetration between the concave objects can be eliminated.

Here, the case in which the concave objects osculate with a plurality of convex segments as shown in FIG. 17 will be examined again. The collisions are caused between the convex segment B2 and the convex segment A1, and between the convex segment B2 and the convex segment A3.

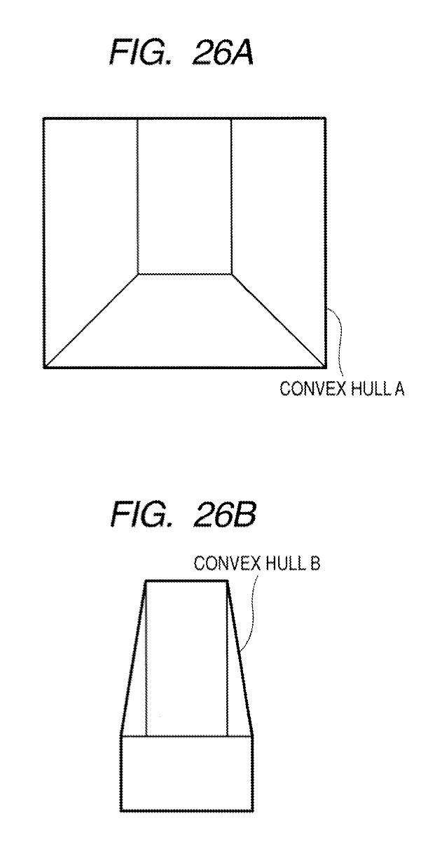

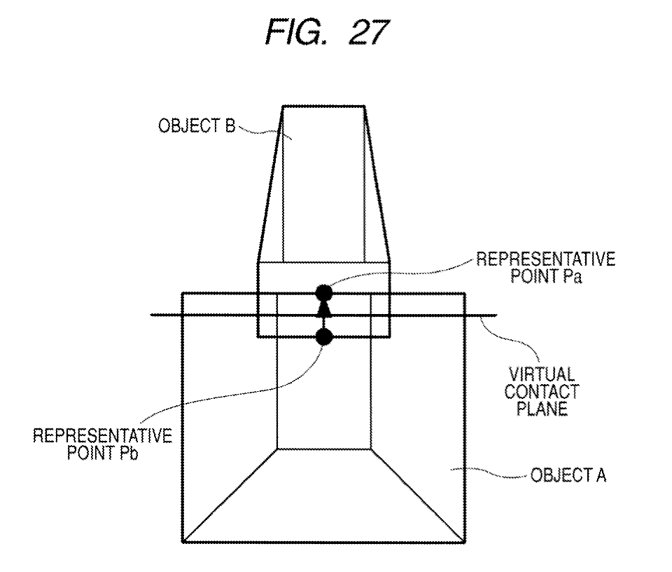

Firstly, the collision detection process between the convex segments B2 and A1 and the collision detection process between the convex segments B2 and A3 are executed. At the same time, the convex hull A and the convex hull B are respectively obtained for the concave objects A and B (see FIG. 26), the interference detection problem regarding the convex hull A and the convex hull B is dealt with, and then a pair of collision representative points {Pₐ, P_{b}} between the convex hull A and the convex hull B is calculated. Then, as the first step, a plane passing through the midpoint of a pair of collision representative points {Pₐ, P_{b}} and having a normal vector expressed by the above formula 1 as a normal line is determined as “a virtual contact plane” (see FIG. 27).

In the subsequent second step, setting the virtual contact plane as the contact planes between the convex segments B2 and A1, and between the convex segments B2 and A3, the apex search is performed under the judgment condition described in the above formula 2. When performing the apex search, using the pair of collision representative points {Pₐ, P_{b}} calculated in the inter-convex hull collision problem and the result (the support pointer) of the support mapping relating to the vector n calculated by the above formula 1 as the origins of the search, the local apex search is performed.

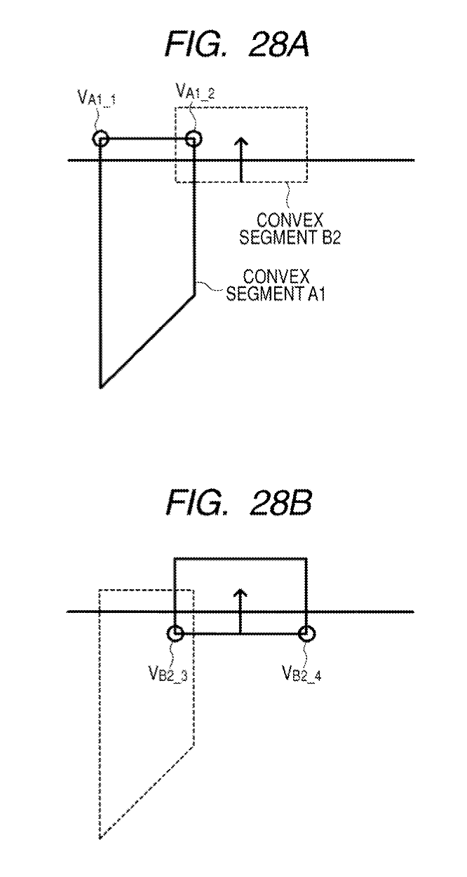

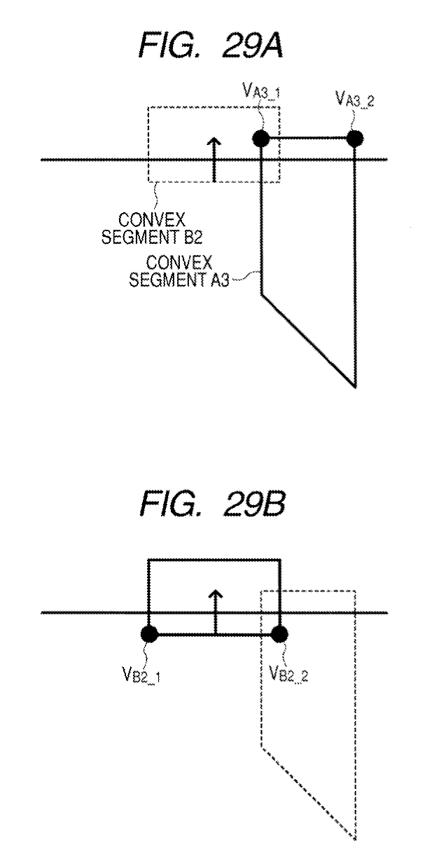

FIGS. 28A and 28B show how the local apex search process is executed using the support points in the convex segments A1 and B2. Here, the apex sets {V_{A1}_{_{—}}₁, V_{A1}_{_{—}}₂} and {V_{B2}_{_{—}}₃, V_{B2}_{_{—}}₄} for providing the shapes of the semi-contact polygons are calculated. Further, FIGS. 29A and 29B show how the local apex search process is executed using the support points in the convex segments A3 and B2. Here, the apex sets {V_{A3}_{_{—}}₁, V_{A3}_{_{—}}₂} and {V_{B2}_{_{—}}₁, V_{B2}_{_{—}}₂} for providing the shapes of the semi-contact polygons are calculated.

It should be noted that it is assumed for the sake of explanatory convenience that the semi-contact polygons {V_{B2}_{_{—}}₃, V_{B2}_{_{—}}₄} and {V_{B2}_{_{—}}₁, V_{B2}_{_{—}}₂} are calculated in the convex segment B2, but these express the same semi-contact polygons because the contact planes used as the judgment condition are the same.

Therefore, in the actual process, there is no need for performing the calculation of the semi-contact polygon repeatedly for one convex segment.

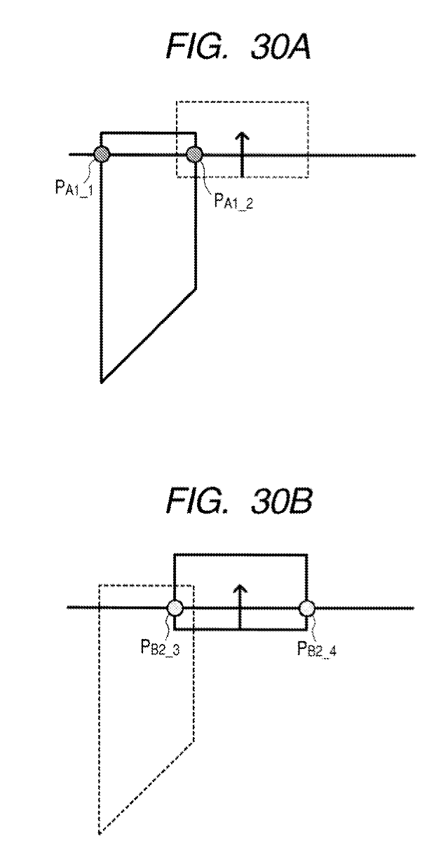

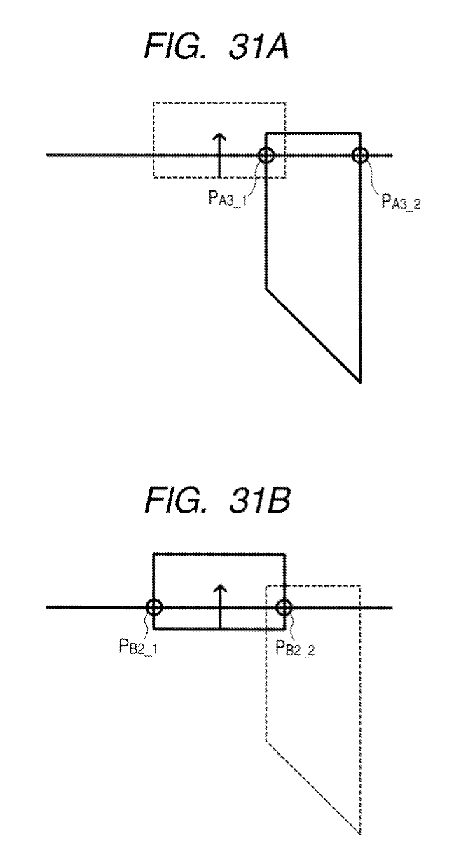

In the subsequent third step, the apex sets of these semi-contact polygons are orthogonally projected on the virtual contact plane set in the second step, and the two-dimensional convex hull operation is performed on the orthogonally projected apex sets. As a result, the boundary apex sets {P_{A1}_{_{—}}₁, P_{A1}_{_{—}}₂}, {P_{B2}_{_{—}}ₑ, P_{B2}_{_{—}}₄}, {P_{A3}_{_{—}}₁, V_{A3}_{_{—}}₂}, {P_{B2}_{_{—}}₁, P_{B2}_{_{—}}₂} as shown in FIGS. 30A, 30B, 31A, 31B can be obtained.

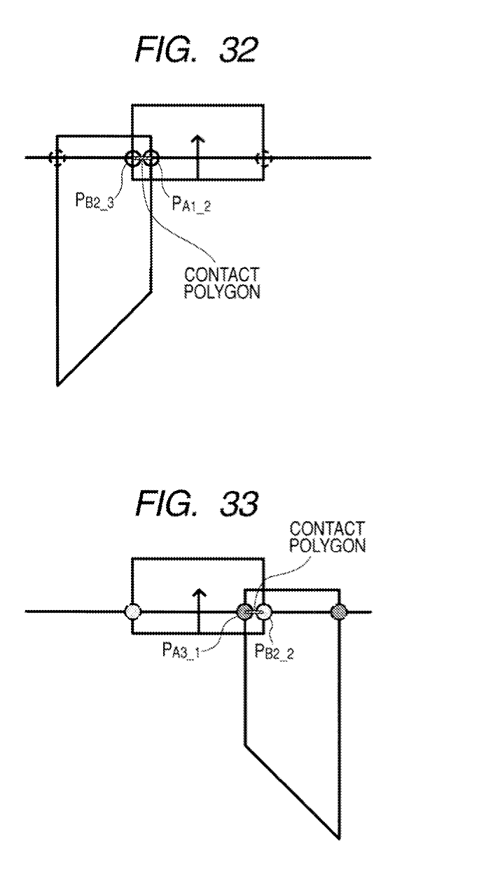

Then, in the last step, the boundary apex sets of the semi-contact polygons respectively obtained between the convex segments A1 and B2, and between the convex segments A3 and B2 are overlapped on the virtual contact plane. As a result, the overlapping areas {P_{B2}_{_{—}}₃, P_{A1}_{_{—}}₂} and {P_{A3}_{_{—}}₁, V_{B2}_{_{—}}₂} respectively shown in FIGS. 32 and 33 can be obtained between the convex segments A1 and B2, and between the convex segments A3 and B2, respectively.

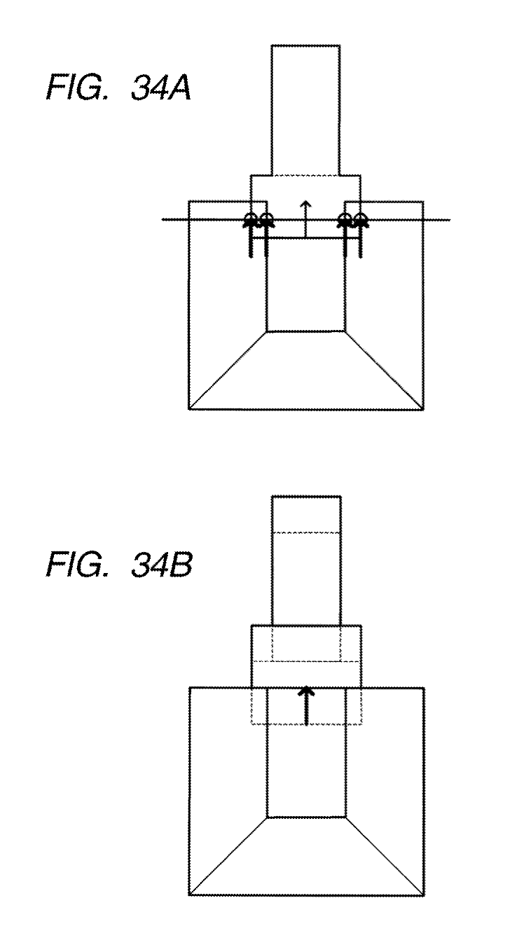

As shown in FIG. 34A, the force is applied to the boundary apexes of the contact polygon of each of the convex segments thus obtained. Then, as shown in FIG. 34B, the penetration problem (geometric inter-object penetration problem) between the objects including the convex segment complex can be solved, and the expected preferable simulation result can be obtained.

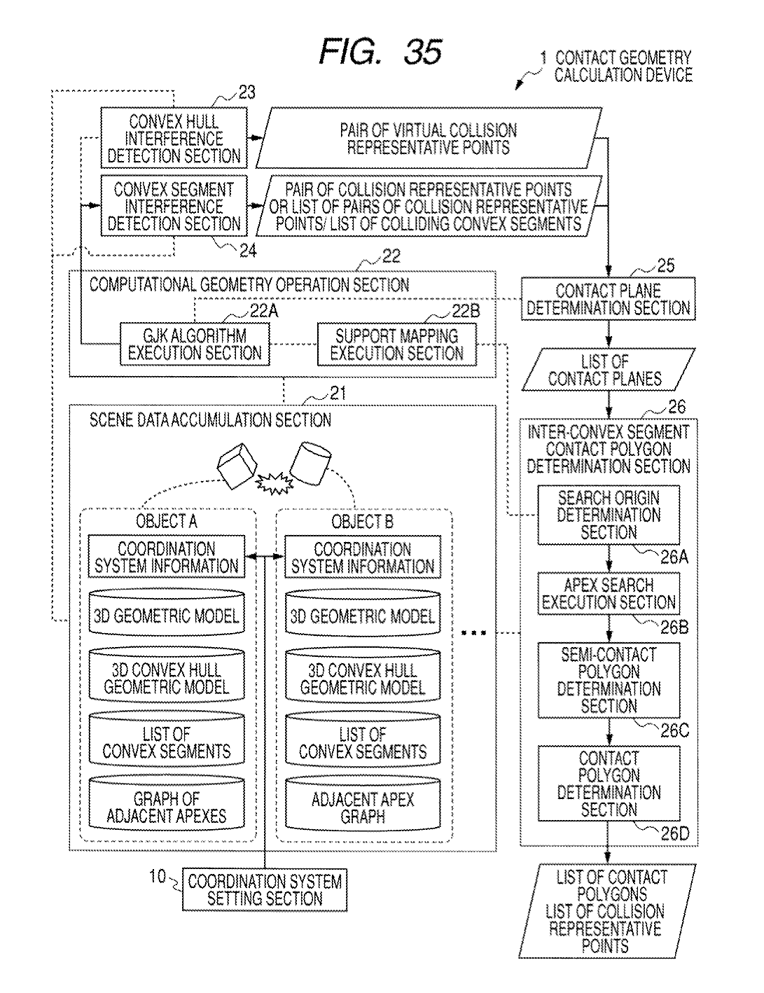

FIG. 35 schematically shows the functional configuration of a contact geometry calculation device for calculating the contact polygon formed between the objects with an arbitrary shape including a concave shape. The contact geometry calculation device 1 as described in the drawing is provided with a coordination system setting section 10 and an interference detection section 20.

The coordination system setting section 10 is means for determining the motion of each object, and is composed, for example, of a dynamics simulation engine.

The interference detection section 20 is composed of a scene data accumulation section 21, a computational geometry operation section 22, a convex hull interference detection section 23, a convex segment interference detection section 24, a contact plane determination section 25, and an inter-convex segment contact polygon determination section 26.

The scene data accumulation section 21 stores, regarding all of the objects existing in the virtual environment, the position and the posture (coordinate information) of the coordinate system set to each object in the world coordination system, and information regarding the geometry of the object. As the geometry data, the three-dimensional geometry model relating to the apexes and faces, a convex hull adjacent apex graph (a three-dimensional convex hull geometry model) as a data structure for showing which apex is connected to the apex composing the convex hull of the convex segment complex and for performing the fast apex search, an adjacent apex graph for describing connection relationships of the apex forming each of the convex segments, and a list of the convex segment group for composing the convex segment complex are stored. The coordinate system information is rewritten according to needs by the coordinate system determination section 10 of the outside for determining the motion of each object.

The computational geometry operation section 22 is provided with a GJK algorithm execution section 22A and a support mapping execution section 22B.

As shown in FIG. 4, the support mapping execution section 22B performs a fundamental operation in the computational geometry field for calculating a point the remotest in a certain vector direction of all the apexes of an arbitrary object.

The GJK algorithm execution section 22A executes a core operation necessary for performing the interference detection process.

The computational geometry operation section 22 repeatedly uses the support mapping repeated by the support mapping execution section 22B to perform collision detection on a pair of objects in the scene data accumulation section 21, which has caused a contact or a collision, and to perform calculation of the collision representative points (the most penetrating point from the EPA algorithm, or the nearest neighbor from the GJK algorithm).

The convex hull interference detection section 23 performs collision detection between the convex segment complexes (the convex hull of the original shape of the object) based on the coordinate system information and the three-dimensional convex hull geometry model in the scene data accumulation section 21 using the result of the fundamental operation in the computational geometry operation section 22, and outputs a pair of virtual collision representative points as a result of the collision detection.

The convex segment interference detection section 24 performs the collision detection process along the GJK algorithm to judge whether or not the convex segments collide with each other, and outputs the list of pairs of colliding convex segments between the respective objects as the result. Further, it can be configured so as to also output the list of pairs of collision representative points.

The contact plane determination section 25, using the pair of virtual collision representative point obtained by the convex hull interference detection section 23, calculated a plane having the vector connecting the collision representative points as the normal line thereof, and passing through the midpoint of the pair of representative points, and obtains the virtual contact plane. The virtual contact plane is set as the contact plane for all of the pair of convex segments causing the collision between the two objects.

The inter-convex segment contact polygon determination section 26 is composed of a search origin determination section 26A, an apex search execution section 26B, a semi-contact polygon determination section 26C, and a contact polygon determination section 26D.

The search origin determination section 26A obtains an apex to be a search origin as a preparation for the collision search process for obtaining a semi-contact polygon of each of the two objects (a pair of convex segments) causing a collision. As the search origin, the result of the support mapping of each of the convex segments in the normal line direction (or the opposite direction thereof) of the contact plane, namely the support point is used.

The apex search execution section 26B obtains set of apexes existing on the side of the counterpart of the contact from the contact plane by a fast local search taking the search origin obtained by the search origin determination section 26A as the origin, and using the adjacent apex graph as the object information of the scene graph.

The semi-contact polygon determination section 26C determines the semi-contact polygon between each pair of objects (convex segments) by extracting the boundary apex set (contour geometry) of the contact plane from the apex set obtained by the apex search execution section 26B.

The contact polygon determination section 26D overlaps the semi-contact polygons of respective pairs of convex segments obtained by the semi-contact polygon determination section 26C on the contact plane, and obtains the intersection area thereof. The intersection area (product area) on the contact plane thus obtained is output as the contact polygon.

The contact geometry calculation device 1 outputs the list of the contact polygons together with the list of pairs of collision representative points relating to all of the collisions as a result of the collision detection. By performing the processing procedures by the functional modules 22 through 26 on all of the combinations of the objects causing a collision and on all of the convex segments causing a collision, the contact polygons can be obtained with respect to all of the collisions between objects caused in the scene data accumulation section 21.

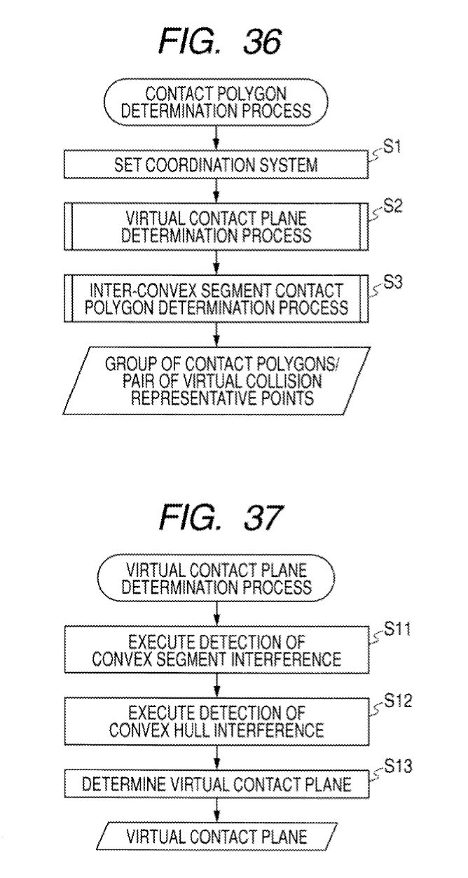

FIG. 36 shows a procedure of the contact polygon determination process executed in the contact geometry calculation device 1 in the form of a flowchart.

Firstly, in the coordinate system setting step (S1), position and posture information of each of the objects is set in the scene data accumulation section 21. The coordination system setting section 10 is composed, for example, of a dynamics simulation engine, and determines the motion of each object.

In the virtual contact plane determination step (S2) subsequent thereto, the virtual contact plane to be used in the succeeding inter-convex segment contact polygon determination step is determined.

Then, in the inter-convex segment contact polygon determination step (S3), the contact plane between each pair of convex segments is determined based on the virtual contact plane determined in the virtual contact plane determination step, and further the contact polygon between each pair of convex segments is determined.

FIG. 37 shows a detailed procedure of the virtual contact plane determination process executed in the step S2 in the form of a flowchart.

In the convex segment interference detection step (S11), the GJK algorithm execution section 22A in the computational geometry operation section 22 obtains all of the combinations of objects and combinations of the convex segments causing a contact or a collision in the scene data accumulation section 21. Further, in this case, it is possible to obtain the pair of collision representative points (a pair of the most penetrating points, or a pair of the nearest points) for each of the pairs of convex segments.

In the convex hull interference detection step (S12), the interference detection process between the convex hull geometries of the convex segment complexes obtained in the preceding convex segment interference detection step is executed by the GJK algorithm execution section 22A in the computational geometry operation section 22, and the pair of collision representative points (a pair of the most penetrating points, or a pair of the nearest points) is obtained for the object (convex segment complex) causing a contact or a collision in the scene data accumulation section 21.

Then, in the virtual contact plane determination step (S13), based on the pair of collision representative points obtained in the preceding convex hull interference detection step, an equation of a plane having the vector connecting the pair of collision representative points as the normal vector, and passing through the midpoint of the pair of representative points is obtained. Further, the plane thus obtained is output as the virtual contact plane.

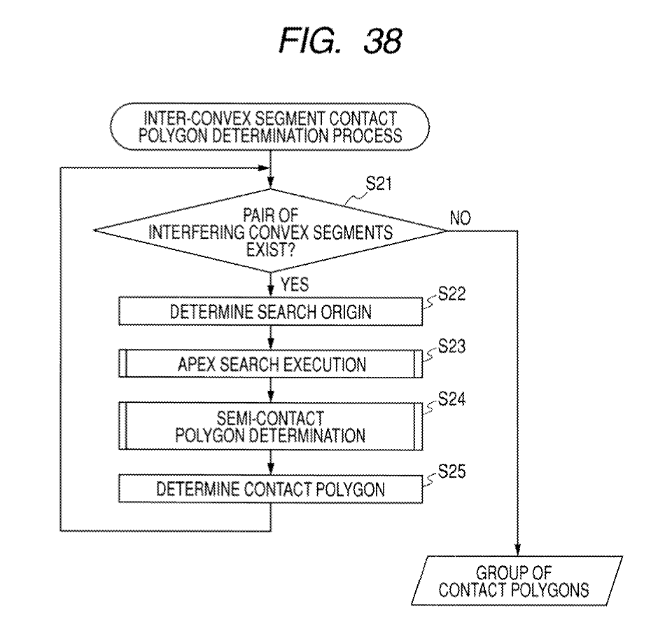

FIG. 38 shows a detailed procedure of the inter-convex contact polygon determination process executed in the step S3 in the flowchart shown in FIG. 36 in the form of a flowchart.

Firstly, between the convex segment complexes, whether or not the pair of convex segments in the condition of contact or collision exist is judged (S21). If the pair of convex segments in the contact or collision condition exists, the process proceeds to the subsequent step S22, and if it does no exist, the pair of contact polygons between the convex segments obtained up to that moment is output as the result of the inter-convex segment contact polygon determination process, and the present process routine is terminated.

In the search origin determination step (S22), the search origin of the adjacent apex graph of the convex segments is obtained. The search origin is assumed to be a result (support point) of the support mapping in the normal line direction (or the opposite direction thereof) of the contact plane when the virtual contact plane obtained in the virtual contact plane determination step (S13) in the flowchart shown in FIG. 36 is set as the contact plane.

In the subsequent apex search execution step (S23), taking the support point set in the preceding search origin determination step as the origin of the search, the local search is executed in the adjacent apex graph of the convex segments to obtain the set of apexes existing on the side of the counterpart of the collision (the other of the pair of convex segments) from the contact plane.

In the subsequent semi-contact polygon determining step (S24), the apex set existing on the side of the counterpart of the collision from the contact plane, which has searched in the preceding apex search execution step, is orthogonally projected on the contact plane, the two-dimensional convex hull operation is performed on the plane, and the contour geometry is extracted as the boundary apex set to calculate the semi-contact polygon.

Then, in the contact polygon determination step (S25), the intersection area (product area) of the pair of semi-contact polygons of each pair of convex segments calculated in the preceding semi-contact polygon determination step is obtained, and is output as the contact polygon.

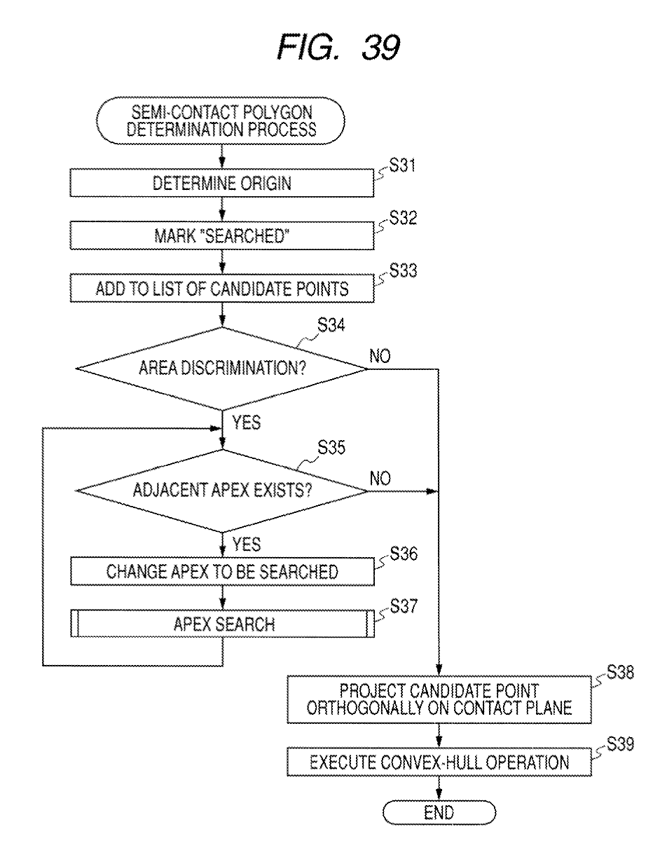

FIG. 39 shows a detailed procedure of the local search process of each of the convex segments executed in the steps S22 through S24 in the flowchart shown in FIG. 38 in the form of a flowchart.

Firstly, the search origin determined in the search origin determination step in the step S22 is set as the origin of the inter-convex segment contact polygon determination process (S31), the “searched” flag is set on the apex used as the origin (S32), and the apex is added to the list of the candidate points (S33).

Subsequently, whether or not the search target point exists on the side of the counterpart of the contact with respect to the contact plane is judged (S34) using the formula 2 described above.

If the search target point exists on the side of the counterpart of the contact with respect to the contact plane (Yes in S34), whether or not an apex exists adjacent to the apex presently searched is further searched (S35) based on the adjacent apex graph.

If the apex exists adjacent to the apex presently searched (Yes in S35), the apex to be the search target is switched from the present apex to the new apex (S36) detected in the step S35. Then, after performing the apex search process defined separately (S37), the process returns to the step S35.

On the other hand, if no search target point exists on the side of the counterpart of the contact with respect to the contact plane (No in S34), or if there is no apex adjacent to the presently searched apex (No in S35), then the candidate points are orthogonally projected on the contact plane (S38), and the two-dimensional convex hull operation is executed on the apex set orthogonally projected to the session plane to obtain (S39) the boundary apex set (i.e., contour apex set) of the semi-contact polygon.

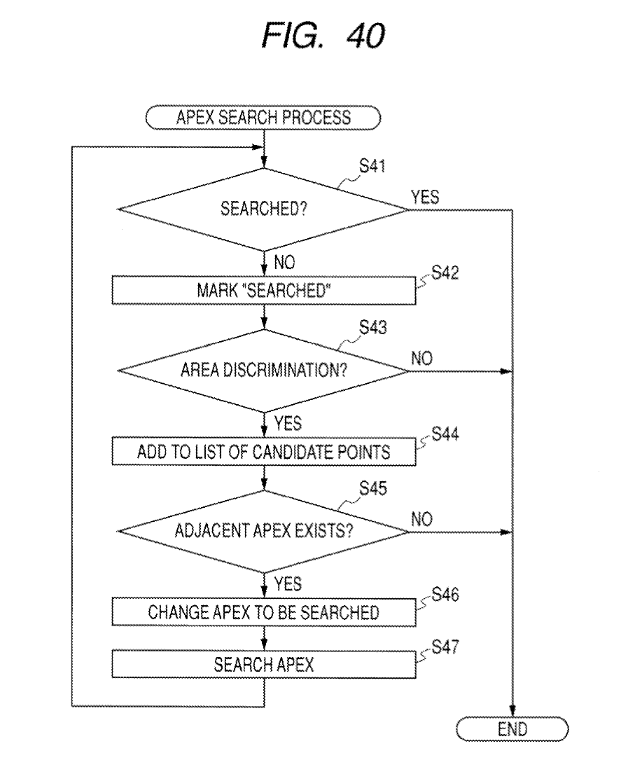

FIG. 40 shows a detailed procedure of the apex search process executed in the step S37 in the flowchart shown in FIG. 39 in the form of a flowchart.

Firstly, whether or not the search target apex has already been searched, namely the “searched” flag is set is confirmed (S41). If it has already been searched, the process returns to S37.

On the other hand, if the apex has not been searched yet (No in S41), the “searched” flag is set (S42).

Subsequently, similarly to the step S34, whether or not the search target point exists on the side of the counterpart of the contact with respect to the contact plane is judged (S43) using the formula 2 described above. If it does not exist on the side of the counterpart of the contact, the process returns to S37.

On the other hand, if the search target point exists on the side of the counterpart of the contact with respect to the contact plane (Yes in S43), the apex presently searched is added to the candidate list (S44).

Subsequently, whether or not the apex exists adjacent to the presently searched apex is searched based on the adjacent apex graph (S45). If not apex exists adjacent to the presently searched apex, the process returns to S37.

On the other hand, if the apex exists adjacent to the apex presently searched (Yes in S45), the apex to be the search target is switched from the present apex to the new apex (S46) detected in the step S45. Then, regarding the new apex, the apex search process is recursively executed.

Hereinabove, the method of calculating the contact polygon in the case in which the penetration is caused in the both objects colliding with each other has been explained. However, similarly to the real world, in the most of the dynamics simulations, the reaction force is applied so that the objects do not penetrate each other. This is also a measure mainly from a viewpoint of the efficiency.

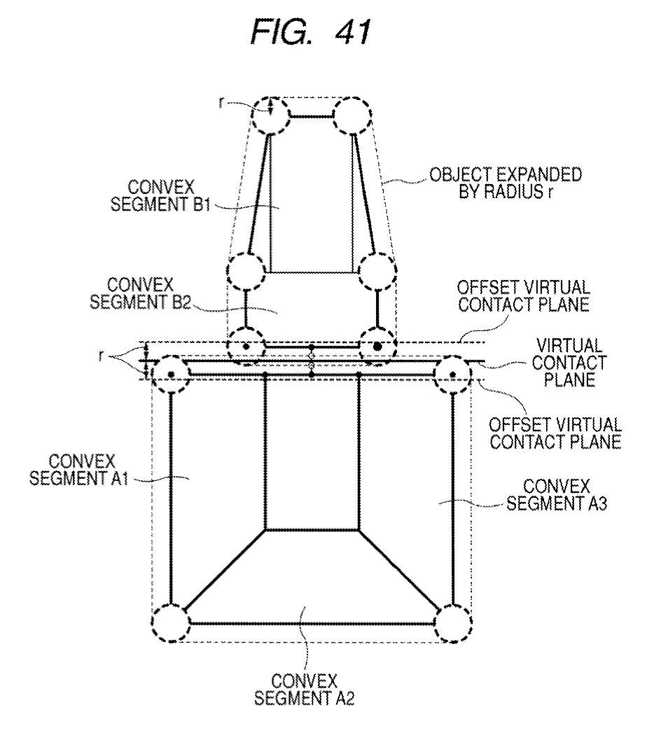

In the case in which the reaction force is generated so that the objects do not penetrate each other, as shown in FIG. 41, the Minkowsky-sum of the convex hull geometry of each object and a sphere, namely, the plane (i.e., offset virtual contact plane) obtained by shifting the virtual contact plane with an offset in a direction of the normal vector, the virtual contact plane being obtained by performing the interference detection on the figure obtained by expanding the convex hull of the object by a radius r of a sphere is defined. Then, it is configured to calculate the semi-contact polygon between the offset virtual contact plane and the shape of the original object before the expansion, namely between the offset virtual contact plane and the convex segment, and to obtain the intersection.

In the case in which there is no interference caused between the original objects, in the GJK algorithm, the collision detection algorithm, the nearest neighbor between the two objects is calculated as a pair of collision representative points. Therefore, in the non-penetration model, the virtual contact plane is defined to pass through the midpoint of the pair of the nearest neighbors and to have the direction connecting the pair of the nearest neighbors as the normal vector thereof.

Although there are various methods of determining the offset amount of the virtual contact plane, it is preferable to arrange that the intersection between the offset virtual contact plane and the original object is assured. For example, when the semi-contact polygon with an object A (convex segment A1) is calculated, a virtual contact plane shifted with an offset by the radius r of the sphere to be used for calculating the Minkowsky-sum of the object A side is considered. Further, when the semi-contact polygon with the object B (convex segment B2) is calculated, it is sufficient to consider the plane shifted with the offset in the opposite direction by r. The search on the adjacent apex graph is performed so that the judgment by the formula 2 is performed between the offset virtual contact plane and the apexes of the original object (convex segment).

Regarding selection of the apex to be the search origin, deletion of the point inside the semi-contact polygon by the two-dimensional convex hull operation, calculation of the semi-contact polygon common area by the intersection operation, and other processing, it is possible to execute with the same procedure as the case with the penetration model.

As described above, the invention is described in detail with reference to the specific embodiment. However, it is obvious that those skilled in the art can perform modifications and alterations of the above embodiment within the scope of the invention.

The contact geometry calculation device according to an embodiment of the invention can preferably be applied to a system necessary for figuring out the variously changing physical contact condition with the surrounding environment such as a locomotive robot. Specifically, by applying the contact geometry calculation process according to the present embodiment of the invention to the three-dimensional geometry model of the environmental shape obtained by the image processing and sensing processing (range sensor) and the locomotive robot itself, the complicated contact condition between the locomotive robot and the environment can be obtained fast, further generalized posture stabilizing control and the motion planning under the various environments can be realized.

In conclusion, the invention is disclosed above as a form of an exemplification, and accordingly, the descriptions in the present specification should not be interpreted in a restrictive manner. The appended claims should be referred to in order for determining the scope of the invention.

It should be understood by those skilled in the art that various modifications, combinations, sub-combinations and alterations may occur depending on design requirements and other factors insofar as they are within the scope of the appended claims or the equivalents thereof.

What is claimed is:

1. A contact geometry calculation device for calculating a contact geometry between two objects with arbitrary shapes in a contact condition, comprising:
convex segment complex obtaining means for one of decomposing each object into a group of convex segments and inputting information of the object decomposed into a group of convex segments;
inter-convex segment collision detection means for detecting a convex segment in one of a colliding condition and a contact condition between the objects one of colliding and osculating with each other;
virtual contact plane determination means for determining a virtual contact plane passing through a common area to convex hulls of the respective objects one of colliding and osculating with each other;
semi-contact problem solving means for solving a contact condition between each of the convex segments and the virtual contact plane one of colliding and osculating with each other as individual semi-contact problems; and
contact polygon determination means for determining a contact polygon between the objects one of colliding and osculating with each other by coordinating the solutions of the semi-contact problems obtained by the semi-contact problem solving means for every convex segment.

2. The contact geometry calculation device according to claim 1,
wherein, the virtual contact plane determination means calculates a pair of convex hull collision representative points composed of one of the nearest neighbor and the most penetrating point between the convex hulls of the respective objects one of colliding and osculating with each other, and determines a virtual contact plane passing through the midpoint of the pair of convex hull collision representative points and having a normal vector directed along a line connecting the pair of convex hull collision representative points.

3. The contact geometry calculation device according to claim 2,
wherein the semi-contact problem solving means obtains a semi-contact polygon for each convex segment in one of a colliding condition and a contact condition with another convex segment, the semi-contact polygon providing a contact geometry with the virtual contact plane, and
the contact polygon determination means obtains a product area for each combination of the convex segments one of colliding and osculating with each other, the semi-contact polygons overlapping on the product area, and determines a contact polygon between the objects by coordinating the product area.

4. The contact geometry calculation device according to claim 3,
wherein, an adjacent apex graph representing connection relationships between the apexes is held for every convex segment, and
the semi-contact problem solving means searches the adjacent apex graph relating to the convex segment to be the processing target to obtain a apex set existing in the semi-contact polygon, recursively performs a local search of the adjacent apex graph until an apex not existing in the virtual session plane is reached taking an appropriate apex as an origin to obtain the apex set existing in the semi-contact polygon.

5. The contact geometry calculation device according to claim 4,
wherein the semi-contact problem solving means sets the apex the most penetrating the convex segment to be the counterpart of the contact in a direction of the normal vector of all of the convex segments to be the processing target as the origin of the local search of the adjacent apex graph.

6. The contact geometry calculation device according to claim 5,
wherein the semi-contact problem solving means sets the apex obtained by a support mapping in the direction of one of the normal vector direction and the inverse direction of the normal vector direction as the origin of the local search of the adjacent apex graph.

7. The contact geometry calculation device according to claim 4,
wherein the semi-contact problem solving means extracts the apex existing on the side of the convex segment to be the counterpart of the contact from the virtual contact plane out of the convex segments to be the processing target as the apex existing in the semi-contact polygon.

8. The contact geometry calculation device according to claim 4,
wherein the semi-contact problem solving means removes the apex existing inside the semi-contact polygon out of the apex set extracted in the convex segment one of colliding and osculating with another convex segment.

9. The contact geometry calculation device according to claim 8,
wherein the semi-contact problem solving means orthogonally projects the apex set extracted as existing in the semi-contact polygon on the virtual contact plane, performs an operation for obtaining the minimum convex polygon apex set including the apex group orthogonally projected, and calculates a contour apex set of the semi-contact polygon excluding the inner point on the virtual contact apex.

10. The contact geometry calculation device according to claim 3, further comprising
object expanding means for generating an expanded object obtained by expanding the convex hull of each object by a predetermined offset amount,
wherein the inter-convex segment collision detection means detects the convex segment in one of a colliding condition and an osculating condition based on one of a collision and a contact between the expanded objects, and
the semi-contact problem solving means calculates the semi-contact polygon between the convex segment of the original object before the expansion and an offset virtual contact plane obtained by translating the virtual contact plane.

11. The contact geometry calculation device according to claim 10,
wherein the inter-convex segment collision detection means calculates a pair of the nearest neighbors between the original objects, which have one of a collision and a contact between the expanded objects, and
the virtual contact plane determination means determines a virtual contact plane passing through the midpoint of the pair of nearest neighbors and having a normal vector directed along a lone connecting the pair of nearest neighbors.

12. The contact geometry calculation device according to claim 11,
wherein the semi-contact problem solving means sets the offset virtual contact plane obtained by translating the virtual contact plane set by the virtual contact plane setting means in the normal vector direction by the offset amount.

13. The contact geometry calculation device according to claim 11,
wherein, the object expanding means sets the offset amount so that an intersection between the offset virtual contact plane and the original object is assured, and
the semi-contact problem solving means calculates the semi-contact polygon between the offset virtual contact plane obtained by translating the virtual contact plane along the normal vector towards the original object by the offset amount and the convex segment.

14. A contact geometry calculation method for calculating a contact geometry between two objects with arbitrary shapes in a contact condition, comprising the steps of:
one of decomposing each object into a group of convex segments and inputting information of the object decomposed into a group of convex segments;
detecting a convex segment in one of a colliding condition and a contact condition between the objects one of colliding and osculating with each other;
determining a virtual contact plane passing through a common area to convex hulls of the respective objects one of colliding and osculating with each other;
solving a contact condition between each of the convex segments and the virtual contact plane one of colliding and osculating with each other as individual semi-contact problems; and
determining a contact polygon between the objects one of colliding and osculating with each other by coordinating the solutions of the semi-contact problems obtained in the solving step for every convex segment.

15. A computer program described in a computer readable form for performing a process for calculating a contact geometry between two objects with arbitrary shapes in a contact condition, the computer program allowing a computer to execute a process comprising the steps of:
one of decomposing each object into a group of convex segments and inputting information of the object decomposed into a group of convex segments;
detecting a convex segment in one of a colliding condition and a contact condition between the objects one of colliding and osculating with each other;
determining a virtual contact plane passing through a common area to convex hulls of the respective objects one of colliding and osculating with each other;
solving a contact condition between each of the convex segments and the virtual contact plane one of colliding and osculating with each other as individual semi-contact problems; and
determining a contact polygon between the objects one of colliding and osculating with each other by coordinating the solutions of the semi-contact problems obtained by the solving step for every convex segment.

16. A contact geometry calculation device for calculating a contact geometry between two objects with arbitrary shapes in a contact condition, comprising:
a convex segment complex obtaining section for one of decomposing each object into a group of convex segments and inputting information of the object decomposed into a group of convex segments;
a inter-convex segment collision detection section for detecting a convex segment in one of a colliding condition and a contact condition between the objects one of colliding and osculating with each other;
a virtual contact plane determination section for determining a virtual contact plane passing through a common area to convex hulls of the respective objects one of colliding and osculating with each other;
a semi-contact problem solving section for solving a contact condition between each of the convex segments and the virtual contact plane one of colliding and osculating with each other as individual semi-contact problems; and
a contact polygon determination section for determining a contact polygon between the objects one of colliding and osculating with each other by coordinating the solutions of the semi-contact problems obtained by the semi-contact problem solving section for every convex segment.
